(19) United States
(12) Patent Application Publication
(10) Pub. No.: US 2013/0141797 A1
(43) Pub. Date: Jun. 6, 2013

(54) ZOOM LENS AND IMAGING APPARATUS

(71) Applicant: Samsung Electronics Co., Ltd., Gyeonggi-do (KR)

(72) Inventor: Hiroyuki HAGIWARA, Kanagawa (JP)

(73) Assignee: Samsung Electronics Co., Ltd., Gyeonggi-do (KR)

(21) Appl. No.: 13/693,746

(22) Filed: Dec. 4, 2012

(30) Foreign Application Priority Data
Dec. 5, 2011 (JP) 2011-265493

(51) Int. Cl. G02B 15/14

(52) U.S. Cl. CPC G02B 15/14
USPC 359/684

(57) ABSTRACT

A zoom lens is provided, and includes, in sequence from an object side: a first lens group with positive refractive power; a second lens group with negative refractive power; a third lens group with positive refractive power; a fourth lens group with positive refractive power; and a fifth lens group with negative refractive power. At the time of a magnification change from a wide-angle end to a telescopic end, the first lens group, the third lens group, and the fifth lens group are fixed in a direction of an optical axis, the second lens group moves along the optical axis from the object side to an image side for the magnification change, the fourth lens group moves along the optical axis to compensate for a change of a position of the image surface according to the movement of the second lens group, and performs focusing. The first lens group includes at least one negative lens and at least three positive lenses, and a cemented lens in which a biconcave negative lens and a positive lens are cemented is disposed on a most object side of the first lens group.

This application claims priority under 35 U.S.C. §119(a) to Japanese Application Serial No. 2011-265493, which was filed in the Japanese Patent Office on Dec. 5, 2011, the entire content of which is hereby incorporated by reference.

### BACKGROUND OF THE INVENTION

1. Field of the Invention

The present invention relates generally to a zoom lens and an imaging apparatus using the same, and more particularly, to a zoom lens that can be appropriately applied to a camera receiving light by an imaging element, such as a security camera, a video camera, or a digital still camera.

2. Description of the Related Art

Conventional examples of a zoom lens with a high quality and a high magnification ratio appropriate for a security camera, a video camera, a digital still camera, and a broadcasting camera are a four-group zoom lens having positive, negative, positive, and positive refractive power, a five-group zoom lens with positive, negative, positive, positive, and positive refractive power, and a five-group zoom lens with positive, negative, positive, positive, and negative refractive power.

The zoom lens changes magnification by moving a second lens group from the object side to the image side, compensates for a change of an image surface accompanied by the magnification change by moving a fourth lens group, and performs focusing.

Since the angle of view at a wide-angle end is required to be wide, a method for complementing the height of the incident off axis light beam by securing the wide effective diameter of a first group has been known for widening the angle of view, such as in Japanese Patent Laid-Open Publication No. 2011-137875. In addition, in order to achieve high variable magnification, a method for promoting a wide angle of view and a high magnification with a five-group configuration with positive, negative, positive, positive, and negative refractive power by dividing four lens groups having an effect of correcting the image surface change has been known, such as in Japanese Patent Laid-Open Publication No. 2007-178598. In addition, as a method for widening an angle of view while an increase of the effective diameter of the first lens is controlled, a method for making a lens in the first lens group with negative refractive power mounted at the most object side be biconcave, and controlling the height of the off axis light beam has been known, such as in Japanese Patent Laid-Open Publication No. 2009-204942 and International Publication No. 2004-025348. In addition, a method for mounting a lens with strong negative refractive power such as a wide conversion lens on a most object side of a first lens group and controlling the height of the incident off axis light beam has been known, such as in Japanese Patent Publication Laid-Open No. 2011-133799.

However, the conventional wide-angle zoom lens may not realize a wide angle of view and a high variable magnification with a small size and a high performance. For example, in a zoom lens presented in Japanese Patent Laid-Open Publication No. 2011-137875, there is a problem in that it is difficult to realize small size and high performance when the effective diameter of the first lens group is increased for widening an angle of view in a four-group zoom lens with positive, negative, positive, and positive refractive power. The conventional four-group zoom lens with positive, negative, positive, and positive refractive power has a problem in that the movement amount of the fourth lens group that performs focusing for a high variable magnification becomes large. In addition, the number of lenses in a driving lens group that perform focusing in order to correct the chromatic aberration at the time of a high variable magnification becomes large, and the actuator that moves the lens group becomes large, so it becomes difficult to achieve small size and high variable magnification. In addition, since the configuration in Japanese Patent Laid-Open Publication No. 2011-137875 realizes the wide angle of view by increasing the effective diameter of the first lens group, the aberration may be appropriately corrected, but the apparatus becomes large, so it is difficult to achieve small size and a wide angle of view.

Also, the zoom lens disclosed in Japanese Patent Laid-Open Publication No. 2009-204942 makes a concave lens in the first lens group mounted on the most object side into a double-concave lens, and regulates the distance to an adjacent lens with positive refractive power to realize a wide angle of view, but since the lens with positive refractive power adjacent to the concave lens is separated, in order to control the eccentricity of each lens when the lens is inserted to the barrel, the size larger than the effective diameter needs to be secured, so it is difficult to achieve a small size and a wide angle of view.

Furthermore, the zoom lens disclosed in International Publication No. 2004-025348 achieves a small size and a wide angle of view by a configuration in which a concave lens in the first lens group on the most object side is a double-concave lens and the concave lens is cemented with an adjacent lens with positive refractive power, but due to the four-group configuration with positive, negative, positive, and positive refractive power, it is difficult to achieve a high variable magnification.

In addition, if a zoom lens is configured by a five-group zoom lens with positive, negative, positive, positive, and positive refractive power as disclosed in Japanese Patent Laid-Open Publication No. 2011-133799, a Petzval sum is excessively biased in a positive direction when the angle of view is widened, so it is difficult to secure high optical performance since the field curvature of the negative image surface increases. In Japanese Patent Laid-Open Publication No. 2011-133799, the front lens diameter of the first lens group is suppressed by mounting a second lens group with strong negative refractive power in front of the first lens group, but the number of lenses in the first lens group increases, so it is difficult to reduce the size of the zoom lens and to widen an angle of view.

Also, if a zoom lens includes a five-group zoom lens with positive, negative, positive, positive, and negative refractive power as disclosed in Japanese Patent Laid-Open Publication No. 2007-178598, the size of the lens with high variable magnification can be reduced, but in conditional expressions of the zoom lens disclosed in Japanese Patent Laid-Open Publication No. 2007-178598, it is difficult to correct the chromatic aberration generated when high variable magnification is further performed or the angle of view is further widened, so it is difficult to achieve a desired variable magnification ratio and a wide angle of view.

In a four-lens group configuration with positive, negative, positive, and positive refractive power, a five-lens group configuration with positive, negative, positive, positive, and positive refractive power, and a five-lens group configuration with positive, negative, positive, positive, and negative refractive power, a second lens group is a movable group with variable magnification function, and a fourth lens group is a movable group with image surface correction and focusing function. However, the four-group zoom lens with positive, negative, positive, and positive refractive power increases the moving amount of the lens group that performs focusing in the high variable magnification, and the number of lenses in the lens group that performs focusing for correcting chromatic aberration becomes large, so the load on the actuator becomes large. In addition, in the case of the five-group zoom lens with positive, negative, positive, positive and positive refractive power, a Petzval sum is excessively biased in a positive direction when the angle of view is widened, so it is difficult to secure high optical performance since the field curvature of the negative image surface increases.

### SUMMARY OF THE INVENTION

Therefore, the present invention has been designed in consideration of the above problems, and an aspect of the present invention is to provide a novel and improved zoom lens and imaging apparatus that can make a variable magnification ratio higher, secure a wider angle of view at the wide angle end, have a smaller size and high performance, and satisfactorily maintain performance at the time of image shift.

In order to solve the problems described above, an aspect of the present invention provides a zoom lens including, in sequence from an object side: a first lens group with positive refractive power; a second lens group with negative refractive power; a third lens group with positive refractive power; a fourth lens group with positive refractive power; and a fifth lens group with negative refractive power. At the time of a magnification change from a wide-angle end to a telescopic end, the first lens group, the third lens group, and the fifth lens group are fixed in a direction of an optical axis, the second lens group moves along the optical axis from the object side to an image side for the magnification change, the fourth lens group moves along the optical axis to compensate for a change of a position of the image surface according to the movement of the second lens group, and performs focusing. The first lens group includes at least one negative lens and at least three positive lenses, and a cemented lens in which a biconcave negative lens and a positive lens are cemented is disposed on a most object side of the first lens group.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a cross-sectional view illustrating a lens at a wide-angle end according to a first embodiment of the present invention;

FIGS. 2A to 2C are diagrams illustrating aberrations at a wide-angle end according to the first embodiment of the present invention;

FIGS. 3A to 3C are diagrams illustrating aberrations at a normal zoom position according to the first embodiment of the present invention;

FIGS. 4A to 4C are diagrams illustrating aberrations at a telescopic end according to the first embodiment of the present invention;

FIG. 5 is a cross-sectional view illustrating a lens at a wide-angle end according to a second embodiment of the present invention;

FIGS. 6A to 6C are diagrams illustrating aberrations at a wide-angle end according to the second embodiment of the present invention;

FIGS. 7A to 7C are diagrams illustrating aberrations at a normal zoom position according to the second embodiment of the present invention;

FIGS. 8A to 8C are diagrams illustrating aberrations at a telescopic end according to the second embodiment of the present invention;

FIG. 9 is a cross-sectional view illustrating a lens at a wide-angle end according to a third embodiment of the present invention;

FIGS. 10A to 10C are diagrams illustrating aberrations at a wide-angle end according to the third embodiment of the present invention;

FIGS. 11A to 11C are diagrams illustrating aberrations at a normal zoom position according to the third embodiment of the present invention;

FIGS. 12A to 12C are diagrams illustrating aberrations at a telescopic end according to the third embodiment of the present invention;

FIG. 13 is a cross-sectional view illustrating a lens at a wide-angle end according to a fourth embodiment of the present invention;

FIGS. 14A to 14C are diagrams illustrating aberrations at a wide-angle end according to the fourth embodiment of the present invention;

FIGS. 15A to 15C are diagrams illustrating aberrations at a normal zoom position according to the fourth embodiment of the present invention;

FIGS. 16A to 16C are diagrams illustrating aberrations at a telescopic end according to the fourth embodiment of the present invention;

FIG. 17 is a cross-sectional view illustrating a lens at a wide-angle end according to a fifth embodiment of the present invention;

FIGS. 18A to 18C are diagrams illustrating aberrations at a wide-angle end according to the fifth embodiment of the present invention;

FIGS. 19A to 19C are diagrams illustrating aberrations at a normal zoom position according to the fifth embodiment of the present invention;

FIGS. 20A to 20C are diagrams illustrating aberrations at a telescopic end according to the fifth embodiment of the present invention;

FIG. 21 is a cross-sectional view illustrating a lens at a wide-angle end according to a sixth embodiment of the present invention;

FIGS. 22A to 22C are diagrams illustrating aberrations at a wide-angle end according to the sixth embodiment of the present invention;

FIGS. 23A to 23C are diagrams illustrating aberrations at a normal zoom position according to the sixth embodiment of the present invention;

FIGS. 24A to 24C are diagrams illustrating aberrations at a telescopic end according to the sixth embodiment of the present invention;

FIG. 25 is a cross-sectional view illustrating a lens at a wide-angle end according to a seventh embodiment of the present invention;

FIGS. 26A to 26C are diagrams illustrating aberrations at a wide-angle end according to the seventh embodiment of the present invention;

FIGS. 27A to 27C are diagrams illustrating aberrations at a normal zoom position according to the seventh embodiment of the present invention; and

FIGS. 28A to 28C are diagrams illustrating aberrations at a telescopic end according to the seventh embodiment of the present invention.

### DETAILED DESCRIPTION OF EMBODIMENTS OF THE PRESENT INVENTION

With reference to the drawings, embodiments of the present invention are described as follows. In addition, throughout the description and drawings, parts having substantially the same function will be denoted by the same reference numerals, and a detailed description thereof may not be provided.

The present invention relates to a five-group zoom lens having zoom lenses with positive, negative, positive, positive, and negative refractive power from the object side. In addition, the present invention secures 70° or more of an angle of view at a wide-angle end and achieves about 45 times of variable magnification ratio by cementing negative lenses included in the first lens group into double-concave lenses. In addition, an image may be shifted by shifting a third lens group in a direction perpendicular to an optical axis. For this, conditional expressions and configurations of a first lens group are presented which have a wide angle without increasing a diameter of the front lens and an appropriately corrected aberration, and further conditional expressions for the third lens group are presented in which an aberration generated at the time of a lens shift in response even to a narrow angle of view at a telescopic end for a high variable magnification is appropriately corrected.

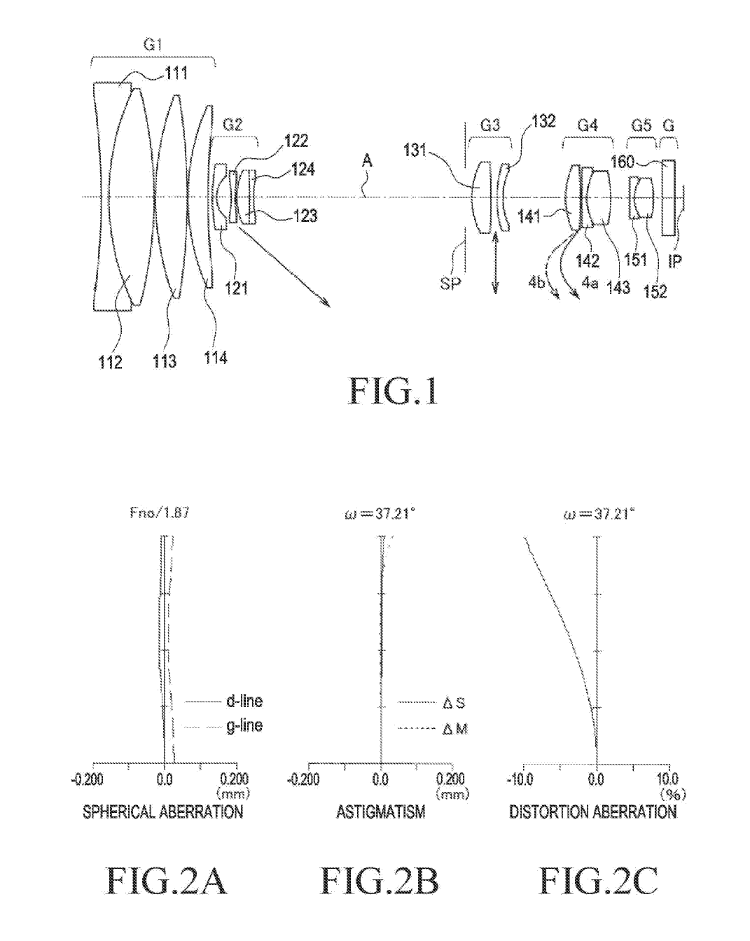

FIG. 1 is a diagram schematically illustrating a zoom lens according to an embodiment of the present invention. In addition, a imaging apparatus according to the present invention includes a zoom lens illustrated in FIG. 1 and an imaging element having an imaging surface on which an image of an object is formed by the zoom lens. FIG. 1 illustrates a zoom lens according to a first embodiment as described below. As illustrated in FIG. 1, the zoom lens includes a first lens group G1 with positive refractive power, a second lens group G2 with negative refractive power, a third lens group G3 with positive refractive power, a fourth lens group G4 with positive refractive power, and a fifth lens group G5 with negative refractive power in sequence from the object side (the left side of FIG. 1), and an aperture SP is disposed on the most object side of the third lens group G3.

The reference number G shown in FIG. 1 is an optical block or a glass block G corresponding to an optical filter 160, a faceplate, a low-pass filter, or the like. The reference number IP denotes an image surface that corresponds to an imaging surface of a solid-state image sensing device (photoelectric transducer) such as a Charge Coupled Device (CCD) sensor or a Complementary Metal Oxide Semiconductor (CMOS) sensor in a photographing optical system of a security camera, a video camera, and a digital still camera, or corresponds to a film surface in a photographing optical system of a silver halide film camera.

At the time of a magnification change from a wide-angle end state to a telescopic end state, the second lens group G2 moves along an optical axis A toward the image surface as directed by an arrow. The second lens group G2 can move back and forth on the optical axis. At this point, the first lens group G1, the third lens group G3, and the fifth lens group G5 are fixed in a direction of the optical axis, and the fourth lens group G4 moves along the optical axis so as to correct the change of an image surface position accompanied by a movement of the second lens group G2 and moves along the optical axis to the object side at the time of short-distance focusing.

The first lens group G1 and the fifth lens group G5 are fixed on the optical axis, and the third lens group G3 can move up and down along a direction perpendicular to the optical axis without moving along the optical axis.

The fourth lens group G4 can move back and forth on the optical axis. The solid line curve 4a and the dotted line curve 4b of the fourth lens group G4 illustrated in FIG. 1 illustrate movement loci for correcting a change of the image surface accompanied by the magnification change from a wide-angle end to a telescopic end at the time of focusing on an infinity object and a close object, respectively. At the time of focusing on the infinity object, the fourth lens group G4 may move to the object side, and then the fourth lens group G4 may move back to the original position of the fourth lens group G4. At the time of focusing on the close object, the fourth lens group G4 may move to the object side, and then the fourth lens group G4 may move back to a position in front of the original position of the fourth lens group G4.

The first lens group G1 includes a cemented lens having a biconcave negative lens 111 on the object side and a positive lens 112 with a convex surface facing the object side, and two positive lenses 113 and 114 with convex surfaces facing the object side. The second lens group G2 includes two negative lenses 121 and 122, and a cemented lens having a positive lens 123 with a convex surface facing the object side and a negative lens 124 in sequence from the object side.

The third lens group G3 includes a biconvex positive lens 131 and a negative lens 132 concave toward the image side in sequence from the object side, and it is configured that an image may be shifted by shifting the third lens group G3 along the direction perpendicular to the optical axis.

In addition, the fourth lens group G4 includes a biconvex positive lens 141 including at least one aspherical surface, and a cemented lens having a negative lens 142 and a positive lens 143 in sequence from the object side, and the fifth lens group G5 includes cemented lens having a negative lens 151 and a positive lens 152 in a cemented manner in sequence from the object side.

The zoom lens according to the embodiment of the present invention includes the first lens group G1 with positive refractive power, the second lens group G2 with negative refractive power, the aperture SP fixed with regard to an image surface, the third lens group G3 with positive refractive power, the fourth lens group G4 with positive refractive power, and the fifth lens group G5 with negative refractive power in sequence from the object side. In the zoom lens, the first lens group G1, the third lens group G3, and the fifth lens group G5 are fixed in the direction of the optical axis at the time of a magnification change from a wide-angle end to a telescopic end, the second lens group G2 moves along the optical axis from the object side to the image side to change magnification, and the fourth lens group G4 moves along the optical axis to compensate the change of the image surface position accompanied by the movement of the second lens group G2 and performs a focusing function. The most object side lenses 111 and 112 of the first lens group G1 include a biconcave negative lens 111 and a positive lens 112 in a cemented manner. This configuration enables a variable magnification ratio to be a higher variable magnification ratio, secures a wide angle of view at the wide-angle end, and forms a small-sized zoom lens with high performance.

Preferably, the first lens group G1 includes at least one negative lens 111 and at least three positive lenses 112, 113, and 114. With this configuration, a spherical aberration especially at the telescopic end can be satisfactorily corrected.

More preferably, at least one of the positive lenses 112, 113, and 114 included in the first lens group G1 is formed of a glass material with an Abbe number of 80 or more, and the first lens group G1 and the negative lens 111 included in the first lens group G1 satisfy the following conditions.

0.2<fl/ft<0.5

(Conditional Expression 1)

1.5<fln/fl<5.0

(Conditional Expression 2)

1.8<Nln

(Conditional Expression 3)

Here, fl represents a focal length of the first lens group G1, ft represents a focal length of the entire lens system at the telescopic end, Nln represents a refractive index in a d-line (587.56 nm) of the negative lens 111 included in the first lens group G1, and fln represents a focal length of the cemented lens 111 and 112 in the first lens group G1 that has a negative lens 111 and a positive lens 112 in a cemented manner.

At least three of the positive lenses included in the first lens group G1 are arranged in order to easily correct the spherical aberration especially at the telescopic end by dispersing positive refractive power. Further, an axial chromatic aberration at the telescopic end and the chromatic aberration of the magnification may be easily corrected by forming the positive lens 112 with the glass material with an Abbe number of 80 or more. In addition, negative refractive power is enhanced by forming the negative lens 111 in the first lens group G1 disposed at the most object side as a biconcave negative lens so that the enlargement of the effective diameter of the lens generated at the time of securing a wide angle of view is prevented from becoming large. In addition, the negative lens 111 forms a cemented lens with the neighboring positive lens 112 so that the combination at the time of being inserted to a barrel becomes simplified and minimized.

Conditional Expression 1 is an expression for regulating a focal length of the first lens group G1 and a focal length of the entire lens system at the telescopic end. If fl/ft is greater than the maximum value of Conditional Expression 1 so that the refractive power of the first lens group G1 becomes weak, the entire length of the zoom lens becomes long, and the lens diameter of the first lens group G1 should be large, so minimization becomes difficult to be achieved, which is not preferable. If fl/ft is less than the minimum value of Conditional Expression 1 so that the refractive power of the first lens group G1 becomes strong, the correction of the various aberrations becomes difficult, so the high performance is difficult to achieve, which is also not preferable.

Preferably, the numerical scope of Conditional Expression 1 is defined to satisfy the following Conditional Expression 1a.

0.3<fl/ft<0.4

(Conditional Expression 1a)

Conditional Expression 2 is an expression for regulating a focal length of the cemented lens 111 and 112 in the first lens group G1 that has the negative lens 111 disposed on the most object side and a positive lens 112 in a cemented manner, and the focal length of the first lens group G1. If |fln/fl| is less than the minimum value of Conditional Expression 2 so that the refractive power of the cemented lens in the first lens group G1 becomes strong, it may be advantageous to strain the effective diameter of the front lens and to secure a wide angle of view, but the astigmatism and the spherical aberration at the telescopic end is likely to be generated. Therefore, this is not preferable. If |fln/fl| is greater than the maximum value of Conditional Expression 2 so that the refractive power of the cemented lens in the first lens group G1 becomes weak, it becomes difficult to secure a wide angle of view with the effective diameter of the front lens restrained, so the minimization becomes difficult to achieve. Therefore, this is also not preferable.

Preferably, the number range of Conditional Expression 2 is defined to satisfy the following Conditional Expression 2a.

2.0<|fln/fl|<3.5 (Conditional Expression 2a)

Conditional Expression 3 is an expression for regulating a refractive index with regard to the d-line (587.56 nm) of the negative lens 111 included in the first lens group G1. If Nln is less than the minimum value of Conditional Expression 3 so that the refractive power of the cemented lens in the first lens group G1 becomes weak, in order to secure the wide angle of view, the effective diameter of the front lens should be large, or the curvature of the negative lens 111 should be small. However, if the effective diameter of the front lens becomes large, minimization becomes difficult to achieve, so it is not preferable. In addition, if the size of the curvature is reduced in order to secure a wide angle of view, it becomes difficult to correct the astigmatism and the spherical aberration of the telescopic end, so it is not preferable.

Meanwhile, if the refractive index of the negative lens 111 is excessively high, the curvature of the lens surface becomes large, and the correction of the various aberrations, especially the correction of the spherical aberration at the wide-angle end, becomes difficult, so it is not preferable. In addition, there may be a disadvantage of deteriorating the transmittance in the visible range, so high performance may not be achieved.

Preferably, the number range of Conditional Expression 3 is defined to satisfy the following Conditional Expression 3a.

1.85<Nln<1.95 (Conditional Expression 3a)

The third lens group G3 includes a biconvex positive lens 131 and a negative lens 132 with a concave surface facing the image side in sequence from the object side. The third lens group G3 includes at least one aspherical surface, an image may be shifted by shifting the third lens group G3 in a direction perpendicular to the optical axis, and the following expression is satisfied.

0.15<f3/ft<0.35 (Conditional Expression 4)

Here, f3 represents a focal length of the third lens group G3, ft represents the focal length of the entire lens system at the telescopic end. The third lens group G3 includes at least one aspherical surface, and it is possible to satisfactorily correct an off-axis aberration generated at the time of the magnification change and the change of an off-axis aberration generated at the time of shifting an image at the same time. In addition, the third lens group G3 includes a positive lens 131 and a negative lens 132, and a chromatic aberration generated at the time of shifting an image may be satisfactorily corrected. Preferably, the positive lens 131 included in the third lens group G3 is a biconvex lens, and the negative lens 132 is a concave lens facing the image side, so the off-axis aberration may be satisfactorily corrected at the time of shifting the lens.

Conditional Expression 4 is an expression for regulating a focal length of the third lens group G3 and a focal length of the entire lens system at the telescopic end. The third lens group G3 is shifted at the time of shifting an image to correct an image shake. If f3/ft is greater than the maximum value of Conditional Expression 4, the refractive power of the third lens group G3 which is a shift lens group becomes excessively weak. Therefore, the work volume required for driving becomes large and minimization of the driving structure may not be achieved. If f3/ft is less than he minimum value of Conditional Expression 4, the refractive power of the third lens group G3 which is a shift lens group becomes excessively strong. Therefore, it becomes complicated to control the image shift correction, and the image shake remains uncorrected, so it is not preferable.

Preferably, the number range of Conditional Expression 4 is defined to satisfy the following Conditional Expression 4a.

0.22<f3/ft<0.32 (Conditional Expression 4a)

The fourth lens group G4 includes a biconvex positive lens 141 with at least one aspherical surface and the cemented lens 142 and 143 having the negative lens 142 and the positive lens 143 in sequence from the object side. The fifth lens group G5 includes the negative lens 151 and the positive lens 152 in a cemented manner, and the following condition is satisfied.

0.08<f4/ft<0.25 (Conditional Expression 5)

0.3<|f5/ft|<1.0 (Conditional Expression 6)

Here, f4 represents the focal length of the fourth lens group G4, f5 represents the focal length of the fifth lens group G5, and ft represents the focal length of the entire lens system at the telescopic end.

The fourth lens group G4 includes at least one aspherical surface, and it is possible to satisfactorily correct various aberrations generated at the time of the magnification change and the change of the various aberrations generated in the focusing operation at the same time. In addition, the fourth lens group G4 includes the biconvex positive lens 141, and the cemented lens having the negative lens 142 and the positive lens 143, the fifth lens group G5 includes the cemented lens having the negative lens 151 and the positive lens 152, so that the chromatic aberration generated at the time of the magnification change may be satisfactorily corrected, and the movement amount for the image surface correction and the focusing operation at the time of the magnification change in the fourth lens group G4 may be reduced by mounting the fifth lens group G5 fixed in the direction of the optical axis and therefore the focusing operation may be performed at a high speed.

Conditional Expression 5 is an expression for regulating a focal length of the fourth lens group G4 and the focal length of the entire lens system at the telescopic end. If f4/ft is greater than the maximum value of Conditional Expression 5 and the refractive power of the fourth lens group G4 becomes weak, the extension amount of the fourth lens group G4 at the time of performing focusing, that is, a moving amount, becomes large, and it becomes difficult to reduce the distance between the third lens group G3 and the fourth lens group G4. Therefore, minimization becomes difficult. If f4/ft is less than the minimum value of Conditional Expression 5 and the refractive power of the fourth lens group G4 becomes strong, it becomes difficult to correct the aberration change at the time of the magnification change from the wide-angle end state to the telescopic end state, so it is not desirable.

Preferably, the number range of Conditional Expression 5 is defined to satisfy the following Conditional Expression 5a.

0.1<f4/ft<0.18 (Conditional Expression 5a)

Conditional Expression 6 is an expression for regulating the focal length of the fifth lens group G5 and the focal length of the entire lens system at the telescopic end. If |f5/ft| is greater than the maximum value of Conditional Expression 6 and the refractive power of the fifth lens group G5 becomes weak, the effect of dividing the fourth lens group G4 becomes small, so the extension amount of the fourth lens group G4 at the time of focusing becomes large, so minimization becomes difficult. If |f5/ft| is less than the minimum value of Conditional Expression 6, and the refractive power of the fifth lens group G5 becomes strong, the generation of various aberrations generated for the image surface correction and the focusing operation at the time of the magnification change becomes large, so it is not preferable.

Preferably, the number range of Conditional Expression 6 is defined to satisfy the following Conditional Expression 6a.

0.45<|f5/ft|<0.70 (Conditional Expression 6a)

More preferably, the second lens group G2 includes at least three negative lenses 121, 122, and 124 and one positive lens 123, and the following condition is satisfied.

0.03<|f2/ft|<0.08 (Conditional Expression 7)

Here, ft represents a focal length of the entire lens system at the telescopic end, and f2 represents the focal length of the second lens group G2.

The second lens group G2 disperses the negative refractive power by arranging at least three negative lenses 121, 122, and 124, and one positive lens 123, and the coma or comatic aberration generated according to the change of the angle of view in the wide-angle end state is corrected to achieve high performance. In addition, preferably, a cemented lens having the positive lens 123 and the negative lens 124 is disposed so that the aberration such as chromatic aberration is satisfactorily corrected, and further, the influence caused by assembly errors at the time of the manufacture is reduced, thereby obtaining a stabilized optical quality.

If |f2/ft| is greater than the maximum value of Conditional Expression 7 and the refractive power of the second lens group G2 becomes weak, the movement amount at the time of magnification change increases, and the entire length becomes long, so it becomes difficult to achieve minimization. Therefore, it is not preferable. If |f2/ft| is less than the minimum value of Conditional Expression 7 and the refractive power of the second lens group G2 becomes strong, it is not preferable since it becomes difficult to satisfactorily correct the change of the aberration at the time of the magnification change from the wide-angle end state to the telescopic end state.

Preferably, the number range of Conditional Expression 7 is defined to satisfy the following Conditional Expression 7a.

0.04<|f2/ft|<0.06 (Conditional Expression 7a)

As described above, by appropriately arranging each lens group in the zoom lens according to the present invention, a high variable magnification ratio is secured, and the angle of view is secured by 70° or more at the wide-angle end, and further, minimization is achieved with maintaining preferable performance at the time of shifting an image.

According to the present invention, it is possible to configure a zoom lens in which in an imaging device such as a security camera, a video camera, a digital still camera, the variable magnification ratio is as high as 45, the angle of view is secured by 70° or more at the wide-angle end, the size is small, the performance is high, and the performance at the time of shifting an image is satisfactorily maintained.

Hereinafter, specific embodiments according to the present embodiment is described. The first to fifth embodiments are specific embodiments appropriate to the Conditional Expressions described above. In each embodiment, the surface number i represents a sequence of optical surfaces from the object side, an aspherical surface is represented as i*, ri represents the curvature radius of the i-th optical surface, di represents the surface distance between the i-th surface and the (i+1)th surface, ndi and vdi represent a refractive index and an Abbe number of the i-th optical member with regard to a d-line, respectively, and rn represents a reference number of a lens or a filter having the corresponding one or two optical surfaces. The back focus BF is a distance from the rear-most lens surface to the paraxial image surface (or a value obtained by air conversion). The entire length of the zoom lens is a value obtained by adding a back focus BF to the distance from the front-most lens surface to the rear-most lens surface.

The unit of length is mm. In addition, the form of the aspherical surface is represented by Equation (1) when K represents a conic integer, A4, A6, A8, and A10 are aspherical surface coefficients, and the displacement in the direction of the optical axis at a position of the height H from the optical axis is represented by x with reference to the surface vertex.

$$X = \frac{( 1 / R ) {H}^{2}}{1 + \sqrt{1 - ( 1 + K ) {( H / R )}^{2}}} + A 4 {H}^{4} + A 6 {H}^{6} + A 8 {H}^{8} + A 10 {H}^{10} \vert \qquad Equation ( 1 )$$

Here, R is a radius of curvature. In addition, the indication of “E-Z” represents “10^{-z}”. f represents a focal length, Fno represents F number, and ω represents a half-angle of view.

### First Embodiment

Tables 1 and 2 are provided for the zoom lens illustrated in FIG. 1.

TABLE 1
Surface Data

| Surface | | | | | |
|---|---|---|---|---|---|
| Number i | ri | di | ndi | νdi | rn |
| Object | ∞ | ∞ | | | |
| Surface | | | | | |
| 1 | −108.820 | 0.930 | 1.90366 | 31.32 | 111 |
| 2 | 31.987 | 6.130 | 1.49700 | 81.61 | 112 |
| 3 | −55.583 | 0.200 | | | |
| 4 | 37.769 | 4.260 | 1.49700 | 81.61 | 113 |
| 5 | −93.711 | 0.150 | | | |
| 6 | 29.521 | 2.670 | 1.80100 | 34.97 | 114 |
| 7 | 104.845 | Variable | | | |
| 8 | 25.531 | 0.500 | 1.88300 | 40.81 | 121 |
| 9 | 3.990 | 1.979 | | | |
| 10 | −19.208 | 0.500 | 1.88300 | 40.81 | 122 |
| 11 | 19.208 | 0.169 | | | |
| 12 | 7.768 | 1.800 | 1.92286 | 20.88 | 123 |
| 13 | −51.096 | 0.500 | 1.88300 | 40.81 | 124 |
| 14 | 16.382 | Variable | | | |
| 15 (Aperture) | ∞ | 0.850 | | | |
| 16* | 9.687 | 2.550 | 1.58916 | 60.60 | 131 |
| 17* | −94.207 | 0.822 | | | |
| 18 | 15.372 | 0.810 | 1.84666 | 23.78 | 132 |
| 19 | 9.049 | Variable | | | |
| 20* | 9.218 | 2.080 | 1.68384 | 31.30 | 141 |
| 21* | −36.486 | 0.158 | | | |
| 22 | 72.901 | 0.69 | 1.80518 | 25.46 | 142 |
| 23 | 7.284 | 3.160 | 1.49700 | 81.61 | 143 |
| 24 | −15.179 | Variable | | | |
| 25 | −41.138 | 0.550 | 1.74400 | 44.79 | 151 |
| 26 | 4.301 | 2.670 | 1.49700 | 81.61 | 152 |
| 27 | −10.119 | 0.15 | | | |
| 28 | ∞ | 1.750 | 1.51633 | 64.14 | 160 |
| 29 | ∞ | 2.100 | | | |
| Image | ∞ | | | | |
| Surface | | | | | |

TABLE 2
Aspherical Surface Data
16th Surface

| | | | |
|---|---|---|---|
| K = 0 | A4 = −6.74E−05 | A6 = −3.45E−07 | A8 = 0 |

17th Surface

| | | | |
|---|---|---|---|
| K = 0 | A4 = 9.24E−05 | A6 = 0 | A8 = 0 |

20th Surface

| | | | |
|---|---|---|---|
| K = 0 | A4 = 1.53E−05 | A6 = −6.63E−06 | A8 = 1.57E−07 |

21st Surface

| | | | |
|---|---|---|---|
| K = 0 | A4 = 3.49E−04 | A6 = −1.02E−05 | A8 = 2.75E−07 |

Various data
Zoom Ratio 42.40

| | Wide | | |
|---|---|---|---|
| | Angle | Normal | Telephoto |
| Focal Length | 2.160 | 23.502 | 91.574 |
| F Number | 1.87 | 3.93 | 3.91 |
| Half-angle of | 37.21 | 3.94 | 1.01 |
| View (°) | | | |
| Image Height | 1.476 | 1.640 | 1.640 |
| Entire Length of | 79.660 | 79.660 | 79.660 |
| Lens | | | |
| BF | 3.414 | 3.414 | 3.414 |
| In the Air | | | |
| d7 | 0.650 | 22.600 | 28.070 |
| d14 | 28.470 | 6.520 | 1.050 |
| d19 | 8.363 | 3.267 | 9.121 |
| d24 | 2.551 | 7.648 | 1.793 |

FIGS. 2A to 2C are diagrams illustrating aberrations at the wide-angle end according to the first embodiment. FIG. 2A is a diagram illustrating a spherical aberration, FIG. 2B is a diagram illustrating astigmatism, and FIG. 2C is a diagram illustrating a distortion aberration.

In aberration diagrams according to the embodiment of the present invention, ΔM represents an Meridional image surface, ΔS represents a Sagittal image surface, ω represents a half-angle of view, and Fno represents an F number being the ratio of the focal length to the diameter of the zoom lens.

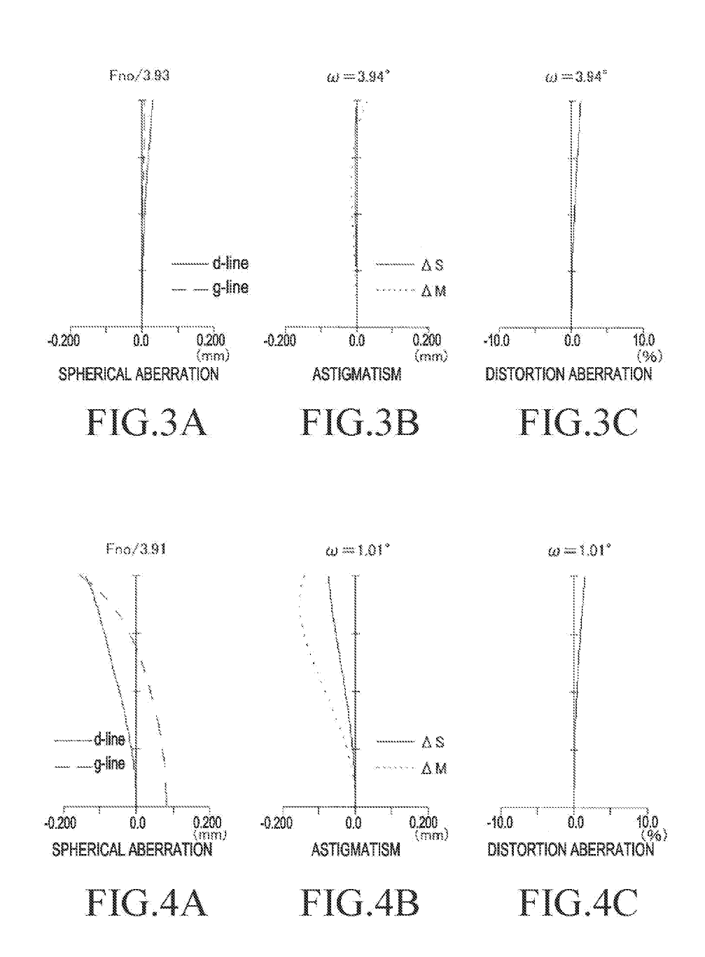

FIGS. 3A to 3C are diagrams illustrating aberrations at a normal zoom position according to the first embodiment of the present invention. FIG. 3A is a diagram illustrating a spherical aberration, FIG. 3B is a diagram illustrating astigmatism, and FIG. 3C is a diagram illustrating a distortion aberration.

FIGS. 4A to 4C are diagrams illustrating aberrations at a telescopic end according to the first embodiment of the present invention. FIG. 4A is a diagram illustrating a spherical aberration, FIG. 4B is a diagram illustrating astigmatism, and FIG. 4C is a diagram illustrating a distortion aberration.

### Second Embodiment

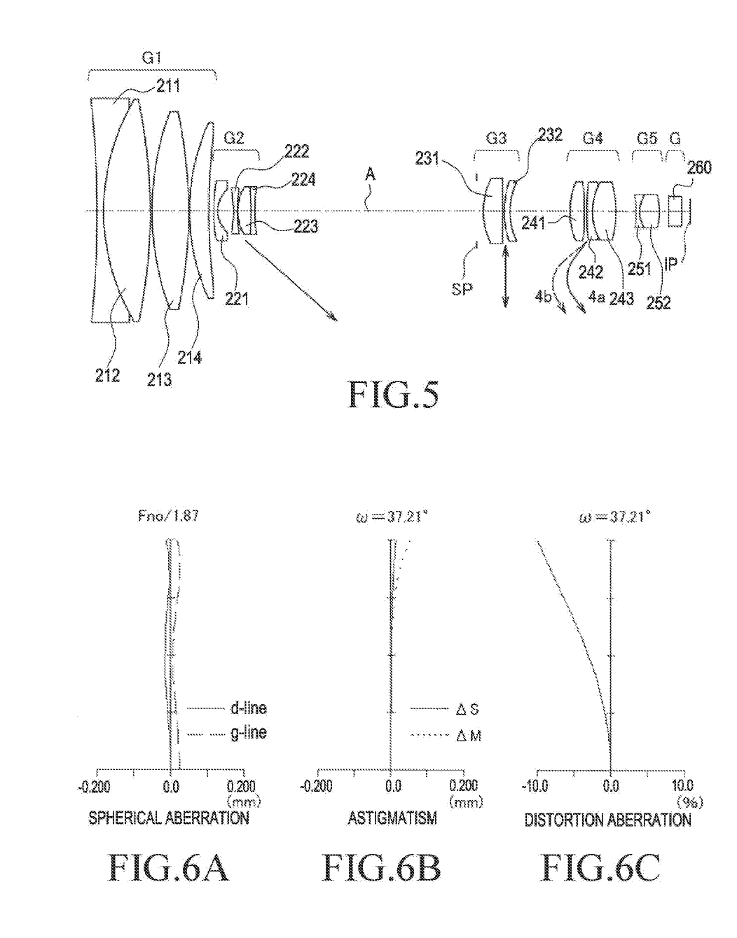

FIG. 5 is a cross-sectional view illustrating a lens at a wide-angle end according to a second embodiment of the present invention.

The zoom lens according to the second embodiment is similar to the zoom lens according to the first embodiment, and there is a difference only in specific numerical values.

As illustrated in FIG. 5, the zoom lens includes the first lens group G1 with positive refractive power, the second lens group G2 with negative refractive power, the third lens group G3 with positive refractive power, the fourth lens group G4 with positive refractive power, and the fifth lens group G5 with negative refractive power in sequence from the object side (the left side of FIG. 5), and the aperture SP is disposed at the most object side of the third lens group G3. The reference number G denotes an optical block or a glass block corresponding to an optical filter 260, a faceplate, a low-pass filter, or the like. The reference number IP denotes an image surface.

The first lens group G1 includes a cemented lens having a biconcave negative lens 211 on the object side and a positive lens 212 with a convex surface facing the object side and two positive lenses 213 and 214 with convex surfaces facing the object side, and the second lens group G2 includes two negative lenses 221 and 222 and a cemented lens having a positive lens 223 and a negative lens 224 in sequence from the object side.

The third lens group G3 includes a biconvex positive lens 231 and a negative lens 232 with a concave surface facing an image side in sequence from the object side, and it is configured so that an image may be shifted by shifting the third lens group G3 in a direction perpendicular to the optical axis.

In addition, the fourth lens group G4 includes a biconvex positive lens 241 having at least one aspherical surface, and a cemented lens having a negative lens 242 and a positive lens 243 in sequence from the object side, and the fifth lens group G5 includes a cemented lens having a negative lens 251 and a positive lens 252 in sequence from the object side.

Tables 3 and 4 are provided for the zoom lens illustrated in FIG. 5.

TABLE 3
Surface Data

| Surface | | | | | |
|---|---|---|---|---|---|
| Number | r | d | nd | νd | rn |
| Object | ∞ | ∞ | | | |
| Surface | | | | | |
| 1 | −129.422 | 0.800 | 1.91082 | 35.25 | 211 |
| 2 | 28.531 | 6.120 | 1.49700 | 81.61 | 212 |
| 3 | −72.786 | 0.200 | | | |
| 4 | 36.644 | 4.800 | 1.49700 | 81.61 | 213 |
| 5 | −63.846 | 0.150 | | | |
| 6 | 29.595 | 2.550 | 1.80400 | 39.59 | 214 |
| 7 | 90.175 | Variable | | | |
| 8 | 24.560 | 0.500 | 1.88300 | 40.81 | 221 |
| 9 | 4.080 | 2.037 | | | |
| 10 | −20.645 | 0.500 | 1.88300 | 40.81 | 222 |
| 11 | 20.645 | 0.150 | | | |
| 12 | 7.829 | 1.740 | 1.92286 | 20.88 | 223 |
| 13 | −73.904 | 0.500 | 1.88300 | 40.81 | 224 |
| 14 | 15.457 | Variable | | | |
| 15 (Aperture) | ∞ | 0.850 | | | |
| 16* | 9.242 | 2.550 | 1.58916 | 60.60 | 231 |
| 17* | −249.872 | 0.150 | | | |
| 18 | 13.310 | 0.820 | 1.84666 | 23.78 | 232 |
| 19 | 8.367 | Variable | | | |
| 20* | 10.006 | 1.950 | 1.68384 | 31.30 | 241 |
| 21* | −39.145 | 0.283 | | | |
| 22 | 43.978 | 0.69 | 1.80518 | 25.46 | 242 |
| 23 | 7.180 | 3.110 | 1.49700 | 81.61 | 243 |
| 24 | −14.700 | Variable | | | |
| 25 | −26.154 | 0.560 | 1.74400 | 44.79 | 251 |
| 26 | 4.445 | 2.640 | 1.49700 | 81.61 | 252 |
| 27 | −9.435 | 0.15 | | | |
| 28 | ∞ | 1.750 | 1.51633 | 64.14 | 260 |
| 29 | ∞ | 2.100 | | | |
| Image | ∞ | | | | |
| Surface | | | | | |

TABLE 4
Aspherical Surface Data
16th Surface

| | | | |
|---|---|---|---|
| K = 0 | A4 = −8.37E−05 | A6 = −7.21E−07 | A8 = 0 |

17th Surface

| | | | |
|---|---|---|---|
| K = 0 | A4 = 7.32E−05 | A6 = 0 | A8 = 0 |

20th Surface

| | | | |
|---|---|---|---|
| K = 0 | A4 = 1.87E−05 | A6 = −1.41E−05 | A8 = 2.11E−07 |

21st Surface

| | | | |
|---|---|---|---|
| K = 0 | A4 = 3.12E−04 | A6 = −2.01E−05 | A8 = 4.36E−07 |

Various Data
Zoom Ratio 42.38

| | Wide | | |
|---|---|---|---|
| | Angle | Normal | Telephoto |
| Focal Length | 2.160 | 23.500 | 91.550 |
| F Number | 1.87 | 3.96 | 4.64 |
| Half-angle of | 37.21 | 3.95 | 1.01 |
| View (°) | | | |
| Image Height | 1.476 | 1.640 | 1.640 |
| Entire Length of | 78.330 | 78.330 | 78.330 |
| Lens | | | |
| BF | 3.412 | 3.412 | 3.412 |
| In the Air | | | |
| d7 | 0.650 | 23.294 | 29.039 |
| d14 | 29.439 | 6.795 | 1.050 |
| d19 | 7.916 | 3.164 | 8.789 |
| d24 | 2.673 | 7.425 | 1.800 |

FIGS. 6A to 6C are diagrams illustrating aberrations at a wide-angle end according to the second embodiment of the present invention. FIG. 6A is a diagram illustrating a spherical aberration, FIG. 6B is a diagram illustrating astigmatism, and

FIG. 6C is a diagram illustrating a distortion aberration.

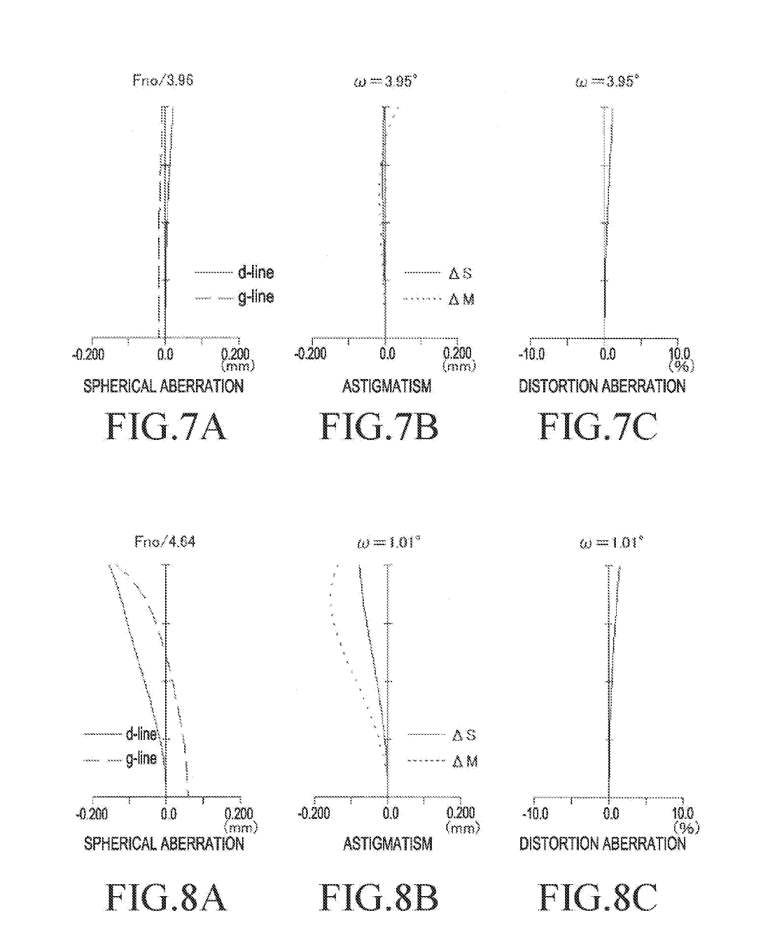

FIGS. 7A to 7C are diagrams illustrating aberrations at a normal zoom position according to the second embodiment of the present invention. FIG. 7A is a diagram illustrating a spherical aberration, FIG. 7B is a diagram illustrating astigmatism, and FIG. 7C is a diagram illustrating a distortion aberration.

FIGS. 8A to 8C are diagrams illustrating aberrations at a telescopic end according to the second embodiment of the present invention. FIG. 8A is a diagram illustrating a spherical aberration, FIG. 8B is a diagram illustrating astigmatism, and FIG. 8C is a diagram illustrating a distortion aberration.

### Third Embodiment

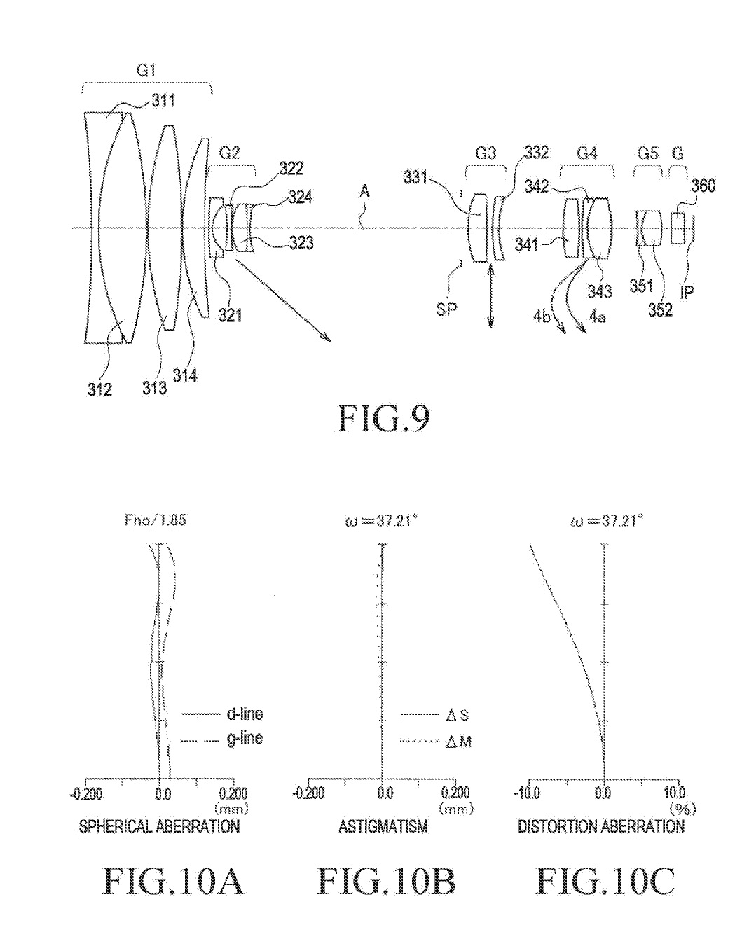

FIG. 9 is a cross-sectional view illustrating a lens at a wide-angle end according to a third embodiment of the present invention.

The zoom lens according to the third embodiment is similar to the zoom lens according to the first embodiment, and there is a difference only in specific numerical values.

As illustrated in FIG. 9, the zoom lens includes the first lens group G1 with positive refractive power, the second lens group G2 with negative refractive power, the third lens group G3 with positive refractive power, the fourth lens group G4 with positive refractive power, and the fifth lens group G5 with negative refractive power in sequence from the object side (the left side of FIG. 9), and the aperture SP is disposed at the most object side of the third lens group G3. The reference number G denotes an optical block or a glass block corresponding to an optical filter 360, a faceplate, a low-pass filter, or the like. The reference number IP denotes an image surface.

The first lens group G1 includes a cemented lens having a biconcave negative lens 311 on the object side and a positive lens 312 with a convex surface facing the object side and two positive lenses 313 and 314 with convex surfaces facing the object side, and the second lens group G2 includes negative lenses 321 and 322 and a cemented lens having a positive lens 323 with a convex surface facing the object side and a negative lens 324 in sequence from the object side.

The third lens group G3 includes a biconvex positive lens 331 and a negative lens 332 with a concave surface facing the image side, and an image may be shifted by shifting the third lens group G3 in a direction perpendicular to the optical axis.

In addition, the fourth lens group G4 includes a biconvex positive lens 341 including at least one aspherical surface and a cemented lens having a negative lens 342 and a positive lens 343 in sequence from the object side, and the fifth lens group G5 includes an cemented lens having a negative lens 351 and a positive lens 352 in an cemented manner.

Tables 5 and 6 are provided for the zoom lens illustrated in FIG. 9.

TABLE 5
Surface Data

| Surface | | | | | |
|---|---|---|---|---|---|
| Number | r | d | nd | νd | rn |
| Object | ∞ | ∞ | | | |
| Surface | | | | | |
| 1 | −111.154 | 0.850 | 1.90366 | 31.32 | 311 |
| 2 | 31.412 | 6.200 | 1.49700 | 81.61 | 312 |
| 3 | −54.844 | 0.200 | | | |
| 4 | 36.767 | 4.450 | 1.49700 | 81.61 | 313 |
| 5 | −83.579 | 0.150 | | | |
| 6 | 27.908 | 2.670 | 1.80100 | 34.97 | 314 |
| 7 | 84.968 | Variable | | | |
| 8 | 28.080 | 0.500 | 1.88300 | 40.81 | 321 |
| 9 | 3.948 | 1.930 | | | |
| 10 | −20.444 | 0.500 | 1.88300 | 40.81 | 322 |
| 11 | 20.444 | 0.150 | | | |
| 12 | 7.343 | 1.840 | 1.92286 | 20.88 | 323 |
| 13 | −69.850 | 0.500 | 1.88300 | 40.81 | 324 |
| 14 | 12.947 | Variable | | | |
| 15 (Aperture) | ∞ | 0.850 | | | |
| 16* | 10.914 | 2.430 | 1.58916 | 60.60 | 331 |
| 17* | −59.653 | 0.776 | | | |
| 18 | 20.020 | 0.830 | 1.84666 | 23.78 | 332 |
| 19 | 11.070 | Variable | | | |
| 20* | 13.620 | 2.100 | 1.68384 | 31.30 | 341 |
| 21* | −40.445 | 0.387 | | | |
| 22 | 25.077 | 0.69 | 1.80518 | 25.46 | 342 |
| 23 | 7.411 | 3.150 | 1.49700 | 81.61 | 343 |
| 24 | −12.550 | Variable | | | |
| 25 | −22.130 | 0.600 | 1.74400 | 44.79 | 351 |
| 26 | 4.606 | 2.630 | 1.49700 | 81.61 | 352 |
| 27 | −8.599 | 0.228 | | | |
| 28 | ∞ | 1.750 | 1.51633 | 64.14 | 360 |
| 29 | ∞ | 2.101 | | | |
| Image | ∞ | | | | |
| Surface | | | | | |

TABLE 6
Aspherical Surface Data
16th Surface

| | | | |
|---|---|---|---|
| K = 0 | A4 = −6.00E−05 | A6 = −1.06E−07 | A8 = 0 |

17th Surface

| | | | |
|---|---|---|---|
| K = 0 | A4 = 7.77E−05 | A6 = 0 | A8 = 0 |

20th Surface

| | | | |
|---|---|---|---|
| K = 0 | A4 = −1.35E−04 | A6 = −2.74E−05 | A8 = 1.48E−07 |

21st Surface

| | | | |
|---|---|---|---|
| K = 0 | A4 = 5.58E−05 | A6 = −3.18E−05 | A8 = 4.24E−07 |

Various Data
Zoom Ratio 46.62

| | Wide | | |
|---|---|---|---|
| | Angle | Normal | Telephoto |
| focal length | 2.160 | 23.500 | 100.699 |
| F Number | 1.85 | 3.86 | 4.82 |
| Half-angle of | 37.21 | 3.95 | 0.92 |
| View (°) | | | |
| Image Height | 1.476 | 1.640 | 1.640 |
| Entire Length of | 78.180 | 78.180 | 78.180 |
| Lens | | | |
| BF | 3.493 | 3.493 | 3.493 |
| In the Air | | | |
| d7 | 0.650 | 21.741 | 27.062 |
| d14 | 27.462 | 6.371 | 1.050 |
| d19 | 8.272 | 3.221 | 9.810 |
| d24 | 3.337 | 8.389 | 1.800 |

FIGS. 10A to 10C are diagrams illustrating aberrations at a wide-angle end according to the third embodiment of the present invention. FIG. 10A is a diagram illustrating a spherical aberration, FIG. 10B is a diagram illustrating astigmatism, and

FIG. 10C is a diagram illustrating a distortion aberration.

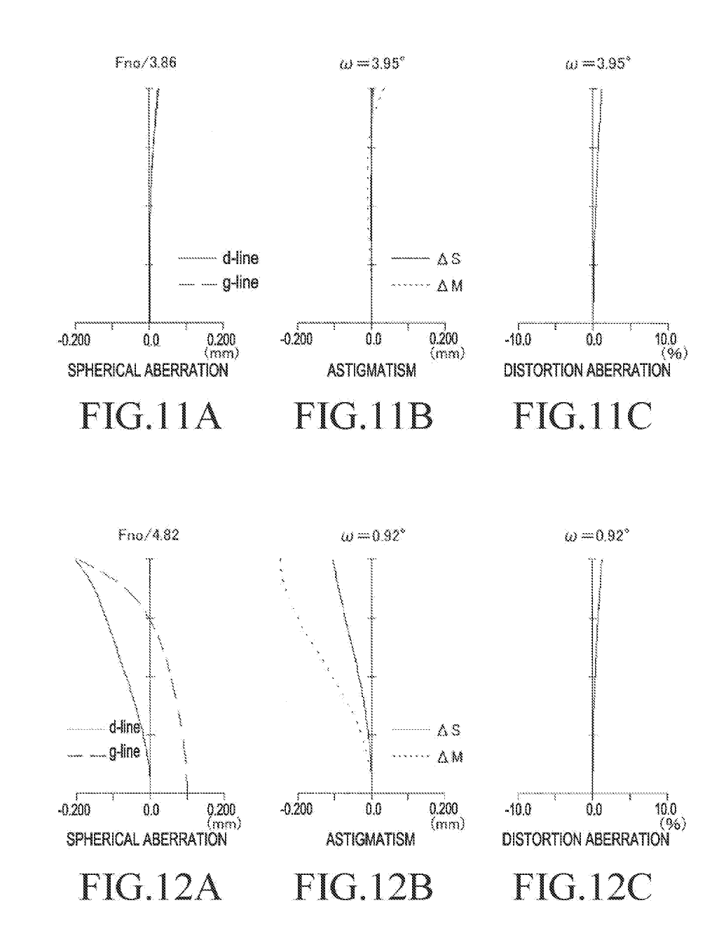

FIGS. 11A to 11C are diagrams illustrating aberrations at a normal zoom position according to the third embodiment of the present invention. FIG. 11A is a diagram illustrating a spherical aberration, FIG. 11B is a diagram illustrating astigmatism, and FIG. 11C is a diagram illustrating a distortion aberration.

FIGS. 12A to 12C are diagrams illustrating aberrations at a telescopic end according to the third embodiment of the present invention. FIG. 12A is a diagram illustrating a spherical aberration, FIG. 12B is a diagram illustrating astigmatism, and FIG. 12C is a diagram illustrating a distortion aberration.

### Fourth Embodiment

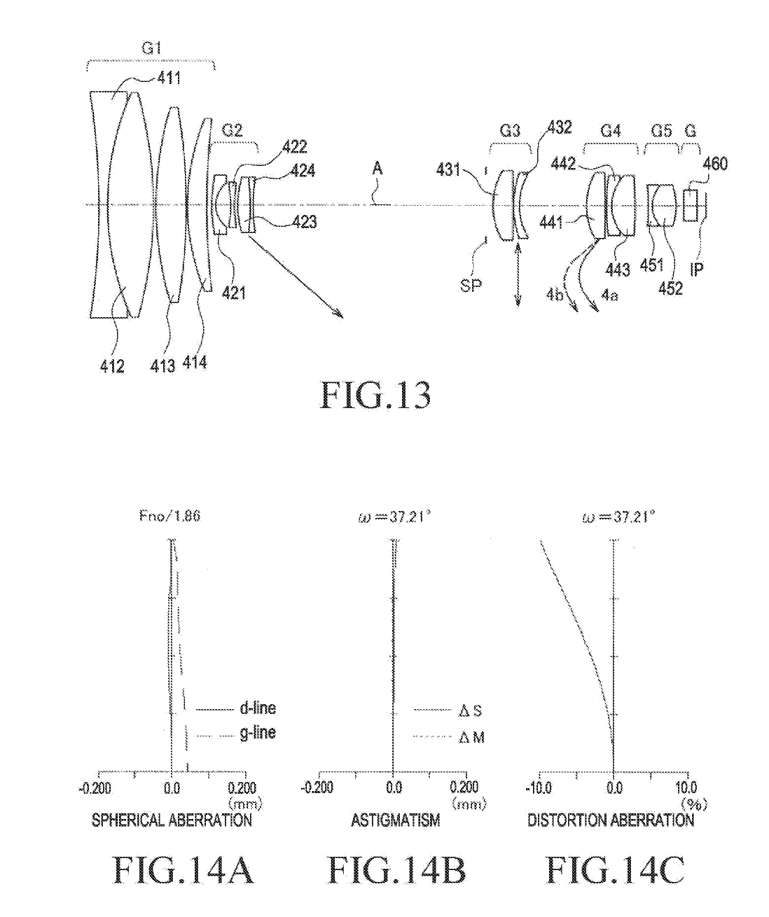

FIG. 13 is a cross-sectional view illustrating a lens at a wide-angle end according to a fourth embodiment of the present invention.

The zoom lens according to the fourth embodiment is similar to the zoom lens according to the first embodiment, and there is a difference only in specific numerical values.

As illustrated in FIG. 13, the zoom lens includes the first lens group G1 with positive refractive power, the second lens group G2 with negative refractive power, the third lens group G3 with positive refractive power, the fourth lens group G4 with positive refractive power, and the fifth lens group G5 with negative refractive power in sequence from the object side (the left side of FIG. 13), and the aperture SP is disposed at the most object side of the third lens group G3. The reference number G denotes an optical block or a glass block corresponding to an optical filter 460, a faceplate, a low-pass filter, or the like. The reference number IP denotes an image surface.

The first lens group G1 includes a cemented lens having a biconcave negative lens 411 on the object side and a positive lens 412 with a convex surface facing the object side and two positive lenses 413 and 414 with convex surfaces facing the object side, and the second lens group G2 includes two negative lenses 421 and 422 and a cemented lens having a positive lens 423 and a negative lens 424 with a convex surface facing the object side, in sequence from the object side.

The third lens group G3 includes a biconvex positive lens 331 and a negative lens 432 with a concave surface facing the image side in sequence from the object side, and an image may be shifted by shifting the third lens group G3 in a direction perpendicular to the optical axis.

In addition, the fourth lens group G4 includes a biconvex positive lens 441 including at least one aspherical surface and a cemented lens having a negative lens 442 and a positive lens 443 in sequence from the object side, and the fifth lens group G5 includes a cemented lens having a negative lens 451 and a positive lens 452 in a cemented manner in sequence from the object side.

Tables 7 and 8 are provided for the zoom lens illustrated in FIG. 13.

TABLE 7
Surface Data

| Surface | | | | | |
|---|---|---|---|---|---|
| Number | r | d | nd | νd | rn |
| Object | ∞ | ∞ | | | |
| Surface | | | | | |
| 1 | −90.043 | 1.050 | 1.90366 | 31.32 | 411 |
| 2 | 37.000 | 6.300 | 1.49700 | 81.61 | 412 |
| 3 | −55.030 | 0.200 | | | |
| 4 | 44.360 | 4.110 | 1.49700 | 81.61 | 413 |
| 5 | −76.637 | 0.150 | | | |
| 6 | 28.837 | 2.540 | 1.80100 | 34.97 | 414 |
| 7 | 80.646 | Variable | | | |
| 8 | 20.677 | 0.500 | 1.88300 | 40.81 | 421 |
| 9 | 4.097 | 2.014 | | | |
| 10 | −16.869 | 0.500 | 1.88300 | 40.81 | 422 |
| 11 | 16.869 | 0.365 | | | |
| 12 | 8.863 | 1.680 | 1.92286 | 20.88 | 423 |
| 13 | −40.995 | 0.500 | 1.88300 | 40.81 | 424 |
| 14 | 25.838 | Variable | | | |
| 15 (Aperture) | ∞ | 0.850 | | | |
| 16* | 8.950 | 2.630 | 1.58916 | 60.60 | 431 |
| 17* | −403.411 | 0.150 | | | |
| 18 | 13.219 | 0.740 | 1.84666 | 23.78 | 432 |
| 19 | 8.156 | Variable | | | |
| 20* | 8.417 | 2.520 | 1.68384 | 31.30 | 441 |
| 21* | −33.348 | 0.179 | | | |
| 22 | 27.233 | 0.7 | 1.80518 | 25.46 | 442 |
| 23 | 5.562 | 3.120 | 1.49700 | 81.61 | 443 |
| 24 | −73.200 | Variable | | | |
| 25 | −31.268 | 0.500 | 1.74400 | 44.79 | 451 |
| 26 | 3.858 | 3.130 | 1.49700 | 81.61 | 452 |
| 27 | −8.098 | 0.155 | | | |
| 28 | ∞ | 1.750 | 1.51633 | 64.14 | 460 |
| 29 | ∞ | 2.100 | | | |
| Image | ∞ | | | | |
| Surface | | | | | |

TABLE 8
Aspherical Surface Data
16th Surface

| | | | |
|---|---|---|---|
| K = 0 | A4 = −6.81E−05 | A6 = −4.87E−07 | A8 = 0 |

17th Surface

| | | | |
|---|---|---|---|
| K = 0 | A4 = 1.06E−04 | A6 = 0 | A8 = 0 |

20th Surface

| | | | |
|---|---|---|---|
| K = 0 | A4 = −2.98E−05 | A6 = −6.01E−07 | A8 = 4.58E−08 |

21th Surface

| | | | |
|---|---|---|---|
| K = 0 | A4 = 2.89E−04 | A6 = −1.28E−06 | A8 = 3.88E−08 |

Various Data
Zoom Ratio 42.38

| | Wide | | |
|---|---|---|---|
| | Angle | Normal | Telephoto |
| Focal Length | 2.160 | 23.500 | 91.550 |
| F Number | 1.86 | 4.17 | 4.81 |
| Half-angle of | 37.21 | 3.95 | 1.01 |
| View (°) | | | |
| Image Height | 1.476 | 1.640 | 1.640 |
| Entire Length of | 80.942 | 80.942 | 80.942 |
| Lens | | | |
| BF | 3.416 | 3.416 | 3.416 |
| In the Air | | | |
| d7 | 0.650 | 24.442 | 30.698 |
| d14 | 31.098 | 7.306 | 1.050 |
| d19 | 8.961 | 3.762 | 8.912 |
| d24 | 1.800 | 6.998 | 1.848 |

FIGS. 14A to 14C are diagrams illustrating aberrations at a wide-angle end according to the fourth embodiment of the present invention. FIG. 14A is a diagram illustrating a spherical aberration, FIG. 14B is a diagram illustrating astigmatism, and FIG. 14C is a diagram illustrating a distortion aberration.

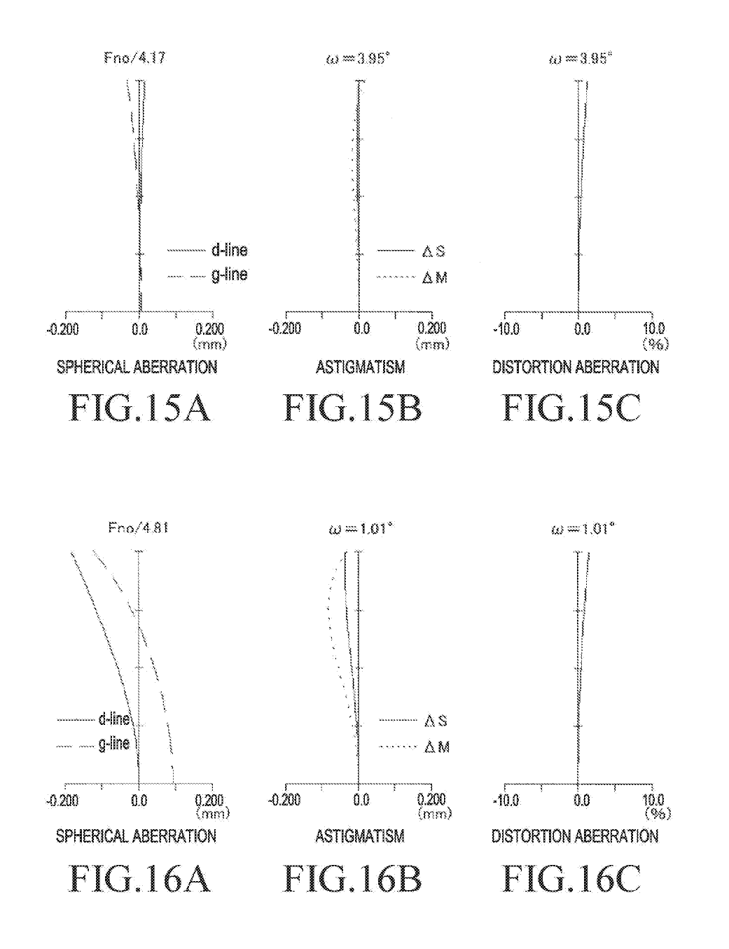

FIGS. 15A to 15C are diagrams illustrating aberrations at a normal zoom position according to the fourth embodiment of the present invention. FIG. 15A is a diagram illustrating a spherical aberration, FIG. 15B is a diagram illustrating astigmatism, and FIG. 15C is a diagram illustrating a distortion aberration.

FIGS. 16A to 16C are diagrams illustrating aberrations at a telescopic end according to the fourth embodiment of the present invention. FIG. 16A is a diagram illustrating a spherical aberration, FIG. 16B is a diagram illustrating astigmatism, and FIG. 16C is a diagram illustrating a distortion aberration.

### Fifth Embodiment

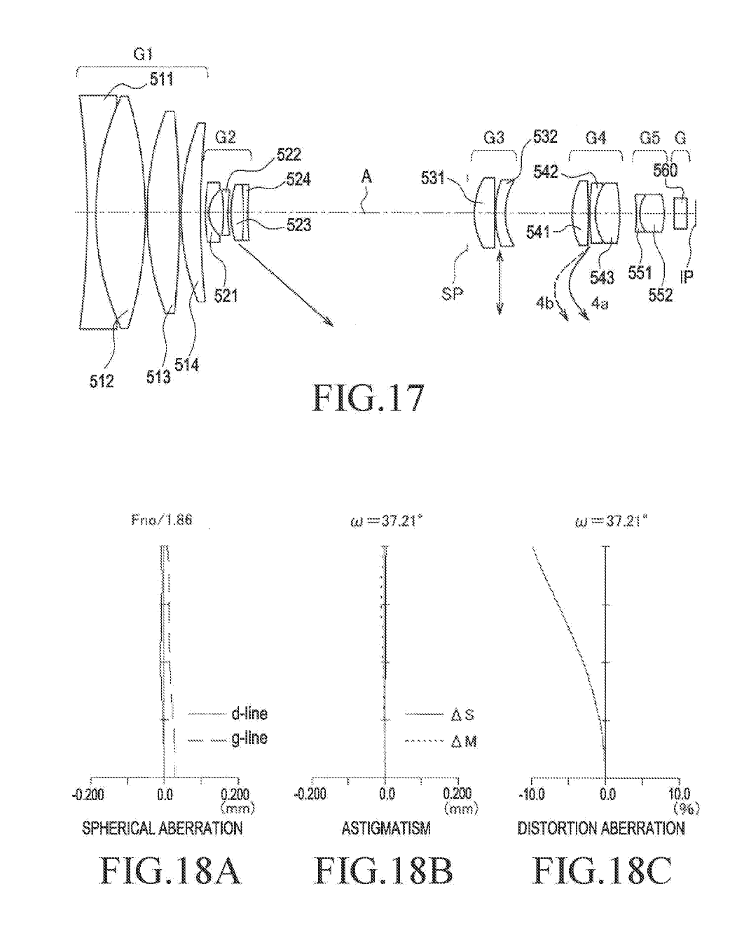

FIG. 17 is a cross-sectional view illustrating a lens at a wide-angle end according to a fifth embodiment of the present invention.

The zoom lens according to the fifth embodiment is similar to the zoom lens according to the first embodiment, and there is a difference only in specific numerical values.

As illustrated in FIG. 17, the zoom lens includes the first lens group G1 with positive refractive power, the second lens group G2 with negative refractive power, the third lens group G3 with positive refractive power, the fourth lens group G4 with positive refractive power, and the fifth lens group G5 with negative refractive power in sequence from the object side (the left side of FIG. 17), and the aperture SP is disposed at the most object side of the third lens group G3. The reference number G denotes an optical block or a glass block corresponding to an optical filter 560, a faceplate, a low-pass filter, or the like. The reference number IP denotes an image surface.

The first lens group G1 includes a cemented lens having a biconcave negative lens 511 on the object side and a positive lens 512 with convex surface facing the object side and two positive lenses 513 and 514 with convex surfaces facing the object side, and the second lens group G2 includes two negative lenses 521 and 522 and a cemented lens having a positive lens 523 with a convex surface facing the object side and a negative lens 424.

The third lens group G3 includes a biconvex positive lens 531 and a negative lens 532 with a concave surface facing the image side in sequence from the object side, and an image may be shifted by shifting the third lens group G3 in sequence perpendicular to the optical axis.

In addition, the fourth lens group G4 includes a biconvex positive lens 541 including at least one aspherical surface and a cemented lens having a negative lens 542 and a positive lens 543 in sequence from the object side, and the fifth lens group G5 includes a cemented lens having a negative lens 551 and a positive lens 552 in a cemented manner in sequence from the object side.

Tables 9 and 10 are provided for the zoom lens illustrated in FIG. 17.

TABLE 9
Surface Data

| Surface | | | | | |
|---|---|---|---|---|---|
| Number | r | d | nd | νd | rn |
| Object | ∞ | ∞ | | | |
| Surface | | | | | |
| 1 | −96.300 | 1.050 | 1.85026 | 32.27 | 511 |
| 2 | 32.665 | 6.300 | 1.49700 | 81.61 | 512 |
| 3 | −48.765 | 0.200 | | | |
| 4 | 34.451 | 4.240 | 1.49700 | 81.61 | 513 |
| 5 | −131.000 | 0.150 | | | |
| 6 | 29.276 | 2.470 | 1.80100 | 34.97 | 514 |
| 7 | 79.360 | Variable | | | |
| 8 | 33.020 | 0.500 | 1.88300 | 40.81 | 521 |
| 9 | 4.100 | 1.835 | | | |
| 10 | −16.764 | 0.500 | 1.88300 | 40.81 | 522 |
| 11 | 16.764 | 0.337 | | | |
| 12 | 8.584 | 1.650 | 1.92286 | 20.88 | 523 |
| 13 | −61.032 | 0.500 | 1.88300 | 40.81 | 524 |
| 14 | 24.238 | Variable | | | |
| 15 (Aperture) | ∞ | 0.850 | | | |
| 16* | 9.225 | 2.600 | 1.58916 | 60.60 | 531 |
| 17* | −161.150 | 0.150 | | | |
| 18 | 14.310 | 1.200 | 1.84666 | 23.78 | 532 |
| 19 | 8.465 | Variable | | | |
| 20* | 8.776 | 2.140 | 1.68384 | 31.30 | 541 |
| 21* | −38.175 | 0.150 | | | |
| 22 | 33.910 | 0.69 | 1.80518 | 25.46 | 542 |
| 23 | 6.375 | 3.140 | 1.49700 | 81.61 | 543 |
| 24 | −22.081 | Variable | | | |
| 25 | −33.090 | 0.500 | 1.74400 | 44.79 | 551 |
| 26 | 3.763 | 3.200 | 1.49700 | 81.61 | 552 |
| 27 | −8.094 | 0.15 | | | |
| 28 | ∞ | 1.750 | 1.51633 | 64.14 | 560 |
| 29 | ∞ | 2.100 | | | |
| Image | ∞ | | | | |
| Surface | | | | | |

TABLE 10
Aspherical Surface Data
16th Surface

| | | | |
|---|---|---|---|
| K = 0 | A4 = −5.68E−05 | A6 = −2.46E−07 | A8 = 0 |

17th Surface

| | | | |
|---|---|---|---|
| K = 0 | A4 = 1.24E−04 | A6 = 0 | A8 = 0 |

20th Surface

| | | | |
|---|---|---|---|
| K = 0 | A4 = 1.70E−06 | A6 = −1.54E−06 | A8 = 1.48E−07 |

21st Surface

| | | | |
|---|---|---|---|
| K = 0 | A4 = 3.21E−04 | A6 = −2.20E−06 | A8 = 1.42E−07 |

Various Data
Zoom Ratio 42.39

| | Wide | | |
|---|---|---|---|
| | Angle | Normal | Telephoto |
| focal length | 2.160 | 23.500 | 91.554 |
| F Number | 1.86 | 4.02 | 4.67 |
| Half-angle of | 37.21 | 3.94 | 1.01 |
| View (°) | | | |
| Image Height | 1.476 | 1.640 | 1.640 |
| Entire Length of | 78.020 | 78.020 | 78.020 |
| Lens | | | |
| BF | 3.411 | 3.411 | 3.411 |
| In the Air | | | |
| d7 | 0.650 | 22.462 | 27.995 |
| d14 | 28.396 | 6.584 | 1.051 |
| d19 | 8.535 | 3.485 | 8.827 |
| d24 | 2.091 | 7.142 | 1.800 |

FIGS. 18A to 18C are diagrams illustrating aberrations at a wide-angle end according to the fifth embodiment of the present invention. FIG. 18A is a diagram illustrating a spherical aberration, FIG. 18B is a diagram illustrating astigmatism, and FIG. 18C is a diagram illustrating a distortion aberration.

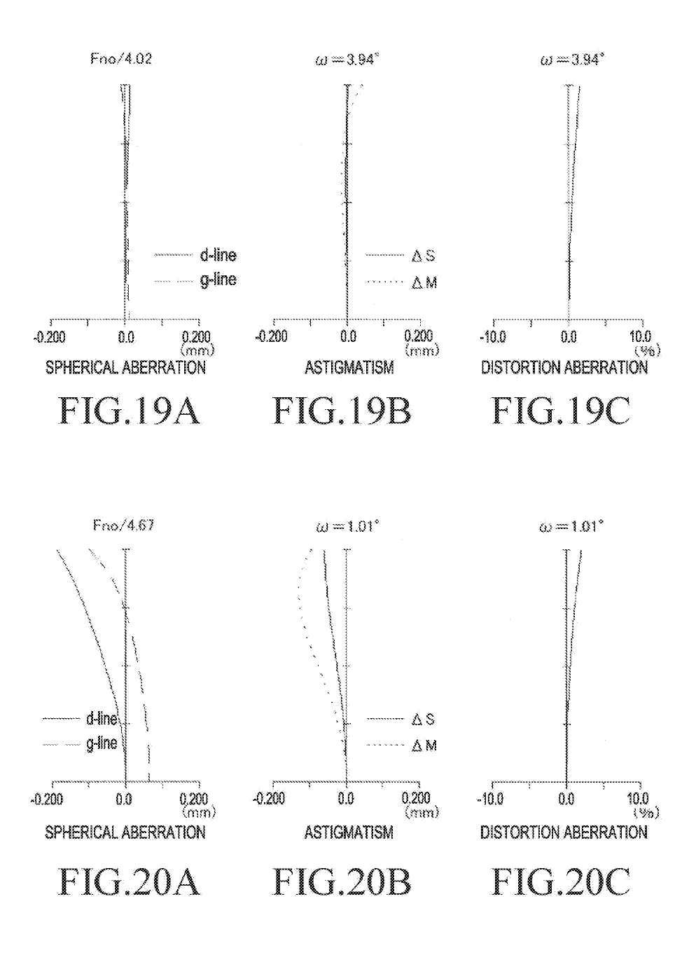

FIGS. 19A to 19C are diagrams illustrating aberrations at a normal zoom position according to the fifth embodiment of the present invention. FIG. 19A is a diagram illustrating a spherical aberration, FIG. 19B is a diagram illustrating astigmatism, and FIG. 19C is a diagram illustrating a distortion aberration.

FIGS. 20A to 20C are diagrams illustrating aberrations at a telescopic end according to the fifth embodiment of the present invention. FIG. 20A is a diagram illustrating a spherical aberration, FIG. 20B is a diagram illustrating astigmatism, and FIG. 20C is a diagram illustrating a distortion aberration.

### Sixth Embodiment

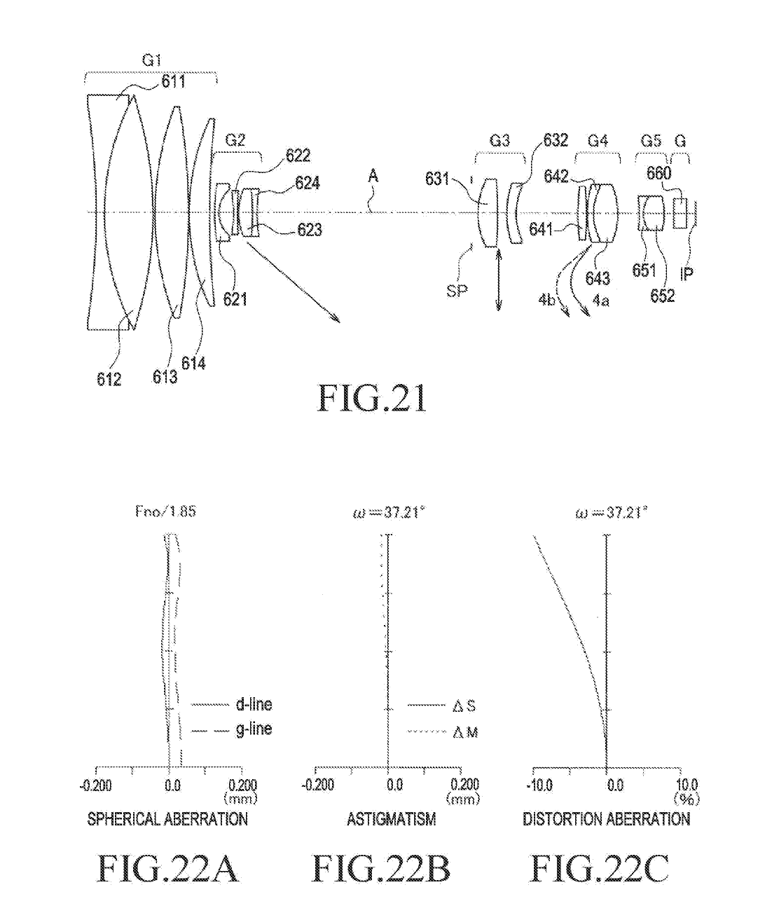

FIG. 21 is a cross-sectional view illustrating a lens at a wide-angle end according to a sixth embodiment of the present invention.

The zoom lens according to the sixth embodiment is similar to the zoom lens according to the first embodiment, and there is a difference only in specific numerical values.

As illustrated in FIG. 21, the zoom lens includes the first lens group G1 with positive refractive power, the second lens group G2 with negative refractive power, the third lens group G3 with positive refractive power, the fourth lens group G4 with positive refractive power, and the fifth lens group G5 with negative refractive power in sequence from the object side (the left side of FIG. 21), and the aperture SP is disposed on the most object side of the third lens group G3. The reference number G denotes an optical block or a glass block corresponding to an optical filter 660, a faceplate, a low-pass filter, or the like. The reference number IP denotes an image surface.

The first lens group G1 includes a cemented lens having a biconcave negative lens 611 on the object side and a positive lens 612 with a convex surface facing the object side, and two positive lenses 613 and 614 with convex surfaces toward the object side, and the second lens group G2 includes two negative lenses 621 and 622, and a cemented lens having a positive lens 623 with a convex surface facing the object side and a negative lens 624 in sequence from the object side.

The third lens group G3 includes a biconvex positive lens 631 and a concave negative lens 632 facing the image side in sequence from the object side, and an image may be shifted by shifting the third lens group G3 in a direction perpendicular to the optical axis.

In addition, the fourth lens group G4 includes a biconvex positive lens 641 including at least one aspherical surface, and a cemented lens having a negative lens 642 and a positive lens 643 in a sequence from the object side, and the fifth lens group G5 includes a cemented lens having a negative lens 651 and a positive lens 652 in sequence from the object side.

Tables 11 and 12 are provided for the zoom lens illustrated in FIG. 21.

TABLE 11
Surface Data

| Surface | | | | | |
|---|---|---|---|---|---|
| Number | r | d | nd | νd | rn |
| Object | ∞ | ∞ | | | |
| Surface | | | | | |
| 1 | −92.836 | 1.050 | 1.90366 | 31.32 | 611 |
| 2 | 32.273 | 6.300 | 1.49700 | 81.61 | 612 |
| 3 | −49.758 | 0.200 | | | |
| 4 | 37.611 | 4.320 | 1.49700 | 81.61 | 613 |
| 5 | −89.225 | 0.150 | | | |
| 6 | 29.007 | 2.700 | 1.80100 | 34.97 | 614 |
| 7 | 101.969 | Variable | | | |
| 8 | 25.360 | 0.500 | 1.88300 | 40.81 | 621 |
| 9 | 3.965 | 1.906 | | | |
| 10 | −18.849 | 0.500 | 1.88300 | 40.81 | 622 |
| 11 | 18.849 | 0.159 | | | |
| 12 | 7.655 | 1.860 | 1.92286 | 20.88 | 623 |
| 13 | −42.899 | 0.500 | 1.88300 | 40.81 | 624 |
| 14 | 14.814 | Variable | | | |
| 15 (Aperture) | ∞ | 0.850 | | | |
| 16* | 9.640 | 2.570 | 1.62263 | 58.16 | 631 |
| 17* | −94.900 | 1.252 | | | |
| 18 | 13.367 | 1.200 | 1.92286 | 20.88 | 632 |
| 19 | 8.226 | Variable | | | |
| 20* | 15.746 | 1.040 | 1.69350 | 53.19 | 641 |
| 21* | 74.802 | 0.150 | | | |
| 22 | 13.700 | 0.83 | 1.76200 | 40.10 | 642 |
| 23 | 6.800 | 3.130 | 1.49700 | 81.61 | 643 |
| 24 | −9.765 | Variable | | | |
| 25 | −25.203 | 0.560 | 1.74400 | 44.79 | 651 |
| 26 | 4.388 | 2.710 | 1.49700 | 81.61 | 652 |
| 27 | −8.825 | 0.15 | | | |
| 28 | ∞ | 1.750 | 1.51633 | 64.14 | 660 |
| 29 | ∞ | 2.100 | | | |
| image surface | ∞ | | | | |

TABLE 12
Aspherical Surface Data
16th Surface

| | | | |
|---|---|---|---|
| K = 0 | A4 = −3.85E−05 | A6 = 1.98E−07 | A8 = 0 |

17th Surface

| | | | |
|---|---|---|---|
| K = 0 | A4 = 1.34E−04 | A6 = 0 | A8 = 0 |

20th Surface

| | | | |
|---|---|---|---|
| K = 0 | A4 = −1.78E−04 | A6 = −8.94E−05 | A8 = −1.44E−07 |

21st Surface

| | | | |
|---|---|---|---|
| K = 0 | A4 = 7.12E−05 | A6 = −9.84E−05 | A8 = 9.39E−07 |

Various Data
Zoom Ratio 45.65

| | Wide | | |
|---|---|---|---|
| | Angle | Normal | Telephoto |
| Focal Length | 2.160 | 23.500 | 98.608 |
| F Number | 1.85 | 3.76 | 4.86 |
| Half-angle of | 37.21 | 3.94 | 0.94 |
| View (°) | | | |
| Image Height | 1.476 | 1.640 | 1.640 |
| Entire Length of | 77.750 | 77.750 | 77.750 |
| Lens | | | |
| BF | 3.413 | 3.413 | 3.413 |
| In the Air | | | |
| d7 | 0.650 | 22.349 | 27.476 |
| d14 | 27.876 | 6.176 | 1.050 |
| d19 | 8.026 | 3.005 | 8.990 |
| d24 | 2.764 | 7.785 | 1.800 |

FIGS. 22A to 22C are diagrams illustrating aberrations at a wide-angle end according to the sixth embodiment of the present invention. FIG. 22A is a diagram illustrating a spherical aberration, FIG. 22B is a diagram illustrating astigmatism, and FIG. 22C is a diagram illustrating a distortion aberration.

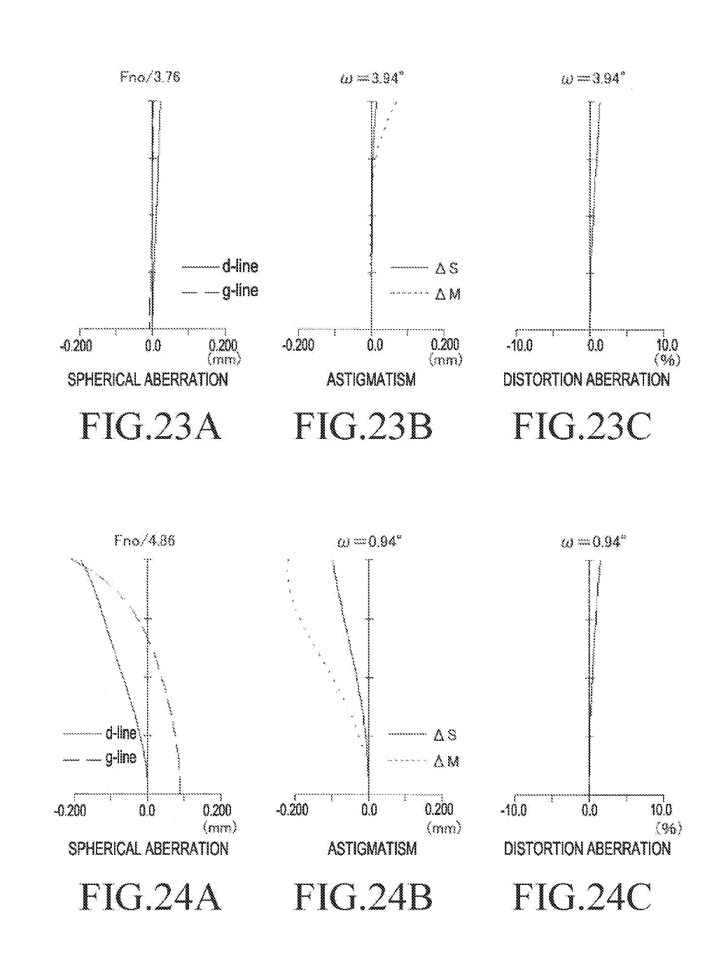

FIGS. 23A to 23C are diagrams illustrating aberrations at a normal zoom position according to the sixth embodiment of the present invention. FIG. 23A is a diagram illustrating a spherical aberration, FIG. 23B is a diagram illustrating astigmatism, and FIG. 23C is a diagram illustrating a distortion aberration.

FIGS. 24A to 24C are diagrams illustrating aberrations at a telescopic end according to the sixth embodiment of the present invention. FIG. 24A is a diagram illustrating a spherical aberration, FIG. 24B is a diagram illustrating astigmatism, and FIG. 24C is a diagram illustrating a distortion aberration.

### Seventh Embodiment

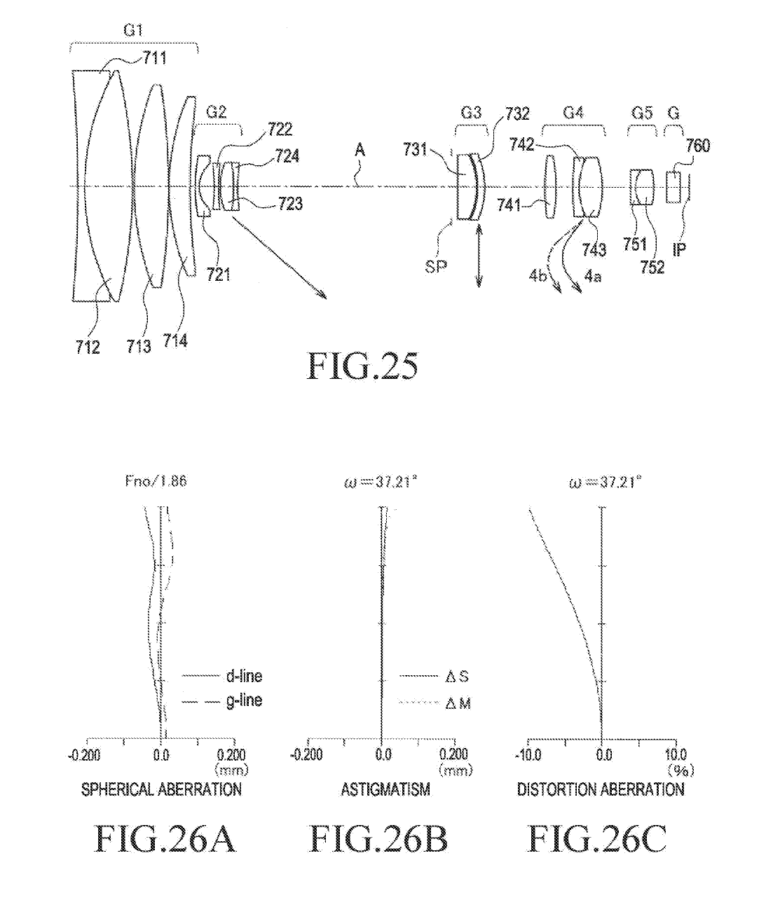

FIG. 25 is a cross-sectional view illustrating a lens at a wide-angle end according to a seventh embodiment of the present invention.

The zoom lens according to the seventh embodiment is similar to the zoom lens according to the first embodiment, and there is a difference only in specific numerical values.

As illustrated in FIG. 25, the zoom lens includes the first lens group G1 with positive refractive power, the second lens group G2 with negative refractive power, the third lens group G3 with positive refractive power, the fourth lens group G4 with positive refractive power, and the fifth lens group G5 with negative refractive power in sequence from the object side (the left side of FIG. 25), and the aperture SP is disposed on the most object side of the third lens group G3. The reference number G denotes an optical block or a glass block corresponding to an optical filter 760, a faceplate, a low-pass filter, or the like. The reference number IP denotes an image surface.

The first lens group G1 includes a cemented lens having a biconcave negative lens 711 on the object side and a positive lens 712 with a concave surface facing the object side, two positive lenses 713 and 714 with convex surfaces facing the object side, and the second lens group G2 includes two negative lenses 721 and 722 in sequence from the object side, and a cemented lens having a positive lens 723 and a negative lens 724 with convex surfaces facing the object side.

The third lens group G3 includes a biconvex positive lens 731 and a negative lens 732 with a concave surface facing the image side in sequence from the object side, and an image may be shifted by shifting the third lens group G3 in a direction perpendicular to the optical axis.

In addition, the fourth lens group G4 includes a biconvex positive lens 741 including at least one aspherical surface, and a cemented lens having a negative lens 742 and a positive lens 743 in sequence from the object side, and the fifth lens group G5 includes a cemented lens having a negative lens 751 and a positive lens 752 in a cemented manner in sequence from the object side.

Tables 13 and 14 are provided for the zoom lens illustrated in FIG. 25.

TABLE 13
Surface Data

| Surface | | | | | |
|---|---|---|---|---|---|
| Number | r | d | nd | νd | rn |
| Object | ∞ | ∞ | | | |
| Surface | | | | | |
| 1 | −159.900 | 0.850 | 1.90366 | 31.32 | 711 |
| 2 | 29.874 | 6.110 | 1.49700 | 81.61 | 712 |
| 3 | −64.452 | 0.200 | | | |
| 4 | 35.383 | 4.390 | 1.49700 | 81.61 | 713 |
| 5 | −98.659 | 0.150 | | | |
| 6 | 28.717 | 2.680 | 1.80100 | 34.97 | 714 |
| 7 | 95.370 | Variable | | | |
| 8 | 33.093 | 0.500 | 1.88300 | 40.81 | 721 |
| 9 | 4.052 | 1.942 | | | |
| 10 | −19.380 | 0.500 | 1.88300 | 40.81 | 722 |
| 11 | 19.380 | 0.204 | | | |
| 12 | 8.034 | 1.720 | 1.92286 | 20.88 | 723 |
| 13 | −65.940 | 0.500 | 1.88300 | 40.81 | 724 |
| 14 | 18.290 | Variable | | | |
| 15 (Aperture) | ∞ | 0.850 | | | |
| 16* | 182.650 | 2.440 | 1.62263 | 58.16 | 731 |
| 17* | −10.517 | 0.150 | | | |
| 18 | −9.023 | 0.840 | 1.84666 | 23.78 | 732 |
| 19 | −12.828 | Variable | | | |
| 20* | 22.010 | 1.370 | 1.68893 | 31.08 | 741 |
| 21* | −34.238 | 2.295 | | | |
| 22 | 27.590 | 0.69 | 1.80518 | 25.46 | 742 |
| 23 | 7.504 | 3.050 | 1.49700 | 81.61 | 743 |
| 24 | −12.708 | Variable | | | |
| 25 | 1946.780 | 0.700 | 1.74400 | 44.79 | 751 |
| 26 | 4.683 | 2.310 | 1.49700 | 81.61 | 752 |
| 27 | −15.322 | 0.655 | | | |
| 28 | ∞ | 1.750 | 1.51633 | 64.14 | 760 |
| 29 | ∞ | 2.105 | | | |
| image surface | ∞ | | | | |

TABLE 14
Aspherical Surface Data
16th Surface

| | | | |
|---|---|---|---|
| K = 0 | A4 = −2.39E−04 | A6 = −4.65E−07 | A8 = 0 |

17th Surface

| | | | |
|---|---|---|---|
| K = 0 | A4 = −2.27E−04 | A6 = 0 | A8 = 0 |

20th Surface

| | | | |
|---|---|---|---|
| K = 0 | A4 = −1.10E−04 | A6 = −3.40E−05 | A8 = 2.27E−07 |

21st Surface

| | | | |
|---|---|---|---|
| K = 0 | A4 = 1.83E−05 | A6 = −3.69E−05 | A8 = 4.08E−07 |

Various Data
Zoom Ratio 42.38

| | Wide | | |
|---|---|---|---|
| | Angle | Normal | Telephoto |
| Focal Length | 2.160 | 23.500 | 91.550 |
| F Number | 1.86 | 3.86 | 4.61 |
| Half-angle of | 37.21 | 3.95 | 1.01 |
| View (°) | | | |
| Image Height | 1.476 | 1.640 | 1.640 |
| Entire Length of | 78.495 | 78.495 | 78.495 |
| Lens | | | |
| BF | 3.927 | 3.927 | 3.927 |
| In the Air | | | |
| d7 | 0.650 | 21.928 | 27.108 |
| d14 | 27.508 | 6.230 | 1.050 |
| d19 | 7.804 | 2.760 | 9.588 |
| d24 | 3.584 | 8.627 | 1.800 |

FIGS. 26A to 26C are diagrams illustrating aberrations at a wide-angle end according to the seventh embodiment of the present invention. FIG. 26A is a diagram illustrating a spherical aberration, FIG. 26B is a diagram illustrating astigmatism, and FIG. 26C is a diagram illustrating a distortion aberration.

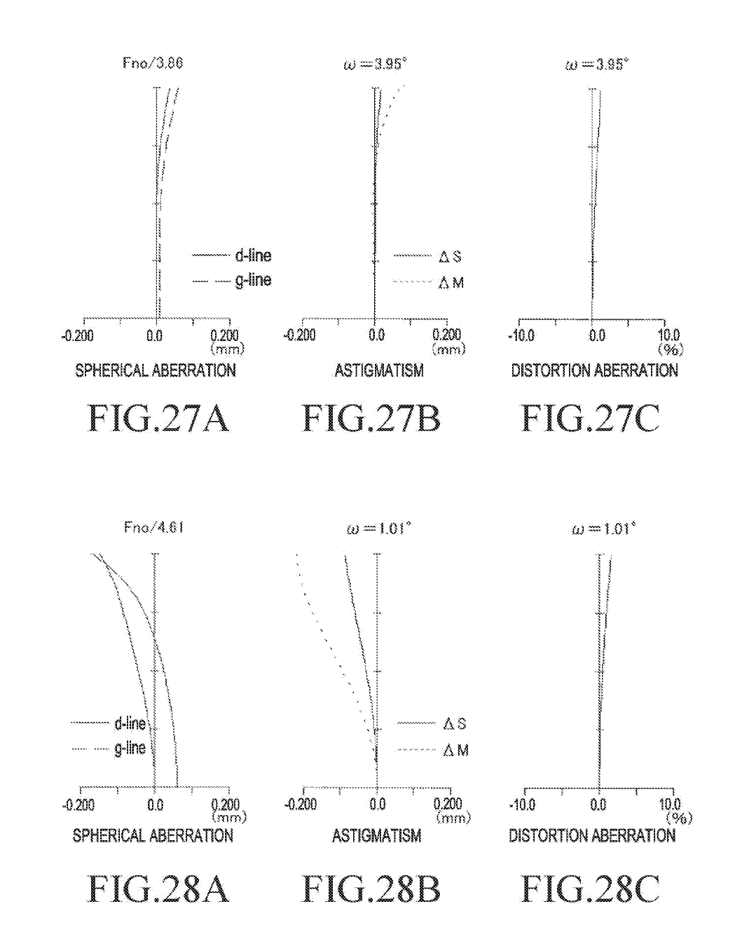

FIGS. 27A to 27C are diagrams illustrating aberrations at a normal zoom position according to the seventh embodiment of the present invention. FIG. 27A is a diagram illustrating a spherical aberration, FIG. 27B is a diagram illustrating astigmatism, and FIG. 27C is a diagram illustrating a distortion aberration.

FIGS. 28A to 28C are diagrams illustrating aberrations at a telescopic end according to the seventh embodiment of the present invention. FIG. 28A is a diagram illustrating a spherical aberration, FIG. 28B is a diagram illustrating astigmatism, and FIG. 28C is a diagram illustrating a distortion aberration.

Table 15 presented below represents conditional expressions corresponding to the respective embodiments. The numerical values are regulated in the respective conditional expressions. Like this, all the embodiments satisfy each conditional expression.

TABLE 15

| Conditional | First | Second | Third | Fourth | Fifth | Sixth | Seventh |
|---|---|---|---|---|---|---|---|
| Expression | Embodiment | Embodiment | Embodiment | Embodiment | Embodiment | Embodiment | Embodiment |
| 1 | 0.359 | 0.368 | 0.316 | 0.387 | 0.361 | 0.324 | 0.352 |
| 2 | 2.640 | 2.071 | 2.752 | 2.481 | 3.441 | 2.696 | 2.784 |
| 3 | 1.904 | 1.911 | 1.904 | 1.904 | 1.850 | 1.904 | 1.904 |
| 4 | 0.284 | 0.287 | 0.270 | 0.293 | 0.282 | 0.228 | 0.305 |
| 5 | 0.123 | 0.123 | 0.112 | 0.130 | 0.121 | 0.107 | 0.154 |
| 6 | 0.539 | 0.455 | 0.474 | 0.700 | 0.700 | 0.479 | 0.617 |
| 7 | 0.049 | 0.051 | 0.042 | 0.051 | 0.048 | 0.043 | 0.049 |

According to the present invention, it is possible to have a higher variable magnification ratio, to secure the wide angle of view at the wide-angle end, and to maintain the satisfactory performance at the time of image shift with a small size and a high performance.

The embodiments of the present invention have been described in detail with reference to the accompanied drawings, but the present invention is not limited thereto. It is apparent to those skilled in the art that various modifications in form and details may be made therein without departing from the spirit and scope of the present invention as defined by the appended claims and it will be understood that the modifications belong to the technical scope of the present invention.

What is claimed is:

1. A zoom lens comprising, in sequence from an object side:
a first lens group with positive refractive power;
a second lens group with negative refractive power;
a third lens group with positive refractive power;
a fourth lens group with positive refractive power; and
a fifth lens group with negative refractive power,
wherein, at the time of a magnification change from a wide-angle end to a telescopic end, the first lens group, the third lens group, and the fifth lens group are fixed in a direction of an optical axis, and the second lens group moves along the optical axis from the object side to an image side for the magnification change,
wherein the fourth lens group moves along the optical axis to compensate for a change of a position of the image surface according to the movement of the second lens group, and performs focusing, and
wherein the first lens group comprises a cemented lens in which a biconcave negative lens and a positive lens are cemented is disposed on a most object side of the first lens group.

2. The zoom lens according to claim 1, wherein the first lens group further comprises at least one negative lens and at least three positive lens.

3. The zoom lens according to claim 2, wherein at least one positive lens in the first lens group is formed from a glass material with an Abbe number of at least 80.

4. The zoom lens according to claim 2, wherein the first lens group and the negative lenses in first lens group satisfy the following condition:
0.2<fl/ft<0.5
1.5<|fln/fl|<5.0
1.8<Nln
where fl represents a focal length of the first lens group, ft represents a focal length in an entire lens system at a telescopic end, Nln represents a refractive index on a d-line (587.56 nm) with regard to a negative lens in the first lens group, and fln is a focal length of the cemented lens in the first lens group in which a negative lens and a positive lens are cemented.

5. The zoom lens according to claim 1, wherein the third lens group comprises a biconvex positive lens and a negative lens convex toward the image side in series from the object side.

6. The zoom lens according to claim 1, wherein the third lens group comprises at least one aspherical surface, an image may be shifted by shifting the third lens group in a direction perpendicular to the optical axis, and a following condition is satisfied:
0.15<f3/ft<0.35
where f3 represents a focal length of the third lens group, and ft represents a focal length of the zoom lens at a telescopic end.

7. The zoom lens according to claim 1, wherein the fourth lens group comprises a biconvex positive lens including at least one aspherical surface and a cemented lens with a negative lens and a positive lens in sequence from the object side, and a following condition is satisfied:
0.08<f4/ft<0.25
0.3<|f5/ft|<1.0
where f4 represents a focal length of the fourth lens group, f5 represents a focal length of the fifth lens group, and ft represents a focal length of the zoom lens at a telescopic end.

8. The zoom lens according to claim 1, wherein the second lens group comprises at least three negative lenses and one positive lens, and a following condition is satisfied:
0.03<|f2/ft|<0.08
where f2 represents a focal length of the second lens group, and ft represents a focal length of the zoom lens at a telescopic end.

9. The zoom lens according to claim 1, further comprising an aperture disposed between the second and third lens groups.
